(19) United States
(12) Patent Application Publication
(10) Pub. No.: US 2024/0066735 A1
(43) Pub. Date: Feb. 29, 2024

(54) HANDHELD ROTARY CUTTER, CUTTING SYSTEM, AND METHODS FOR USING THE SAME

(71) Applicant: Instant Brands Holdings Inc., Downers Grove, IL (US)

(72) Inventors: Tania Louise Aldous, Niles, IL (US); Randy Soibel, Deerfield, IL (US)

(21) Appl. No.: 17/899,384

(22) Filed: Aug. 30, 2022

(51) Int. Cl. B26B 29/00; B25G 1/10; B26B 25/00

(52) U.S. Cl. CPC B26B 29/00; B25G 1/102; B26B 25/005

(57) ABSTRACT

A rotary cutter having a blade holder configured to receive a rotary blade is provided. In some configurations, the rotary cutter has one or more shields slidably connected to a body and configured to move between a retracted position and an extended position. In some configurations, when a first shield is in an extended position it has a portion disposed beyond a first portion of the edge of the rotary blade and when a second shield is a second extended position it has a portion disposed beyond a second portion of the edge of the rotary blade different than the first portion of the rotary blade.

### FIELD

This disclosure relates generally to the field of cutting implements, and specifically to cutting implements with rotary blades.

### BACKGROUND

Handheld cutting implements are commonly used to cut layers of fabric, cardboard, paper, vellum and/or other materials. In one illustrative approach, a handheld cutting implement includes a generally circular knife or cutting blade.

Although such rotary knives may be useful, the safety features typically incorporated therein have drawbacks including, for example, being poorly designed, unstable, and/or difficult to manipulate during use. Indeed, some configurations require extensive manual dexterity. For example, users of some tools require sufficient adroitness to apply manual pressure or force in several different manners or directions simultaneously to ensure that a blade is both exposed and that the tool advance in the desired cutting direction.

In this manner, users without sufficient manual dexterity may be required to use two hands to operate this style of rotary cutter, such that they have no hand free to stabilize the material being cut. Further, even if a user has sufficient manual dexterity to operate the rotary cutter with one hand, continued actuation use of such complicated safety features often causes muscle fatigue in the hand of the user, which may prevent the user from using the rotary knives for an extended period of time. This problem can be especially acute for younger or elderly users who may not be able to repeatedly exert the amount of force needed to manipulate the safety feature of the rotary cutter.

### BRIEF DESCRIPTION OF THE DRAWINGS

The above needs are at least partially met through provision of a handheld rotary cutter, cutting system, and methods of use described in the following detailed description, particularly when studied in conjunction with the drawings, wherein:

FIG. 1 is an elevational side view of one embodiment of a rotary cutter in accordance with various embodiments of these teachings;

FIG. 2 is a side view of the rotary cutter of FIG. 1 showing the side opposite the side shown in FIG. 1;

FIG. 3 is a side view of the rotary cutter of FIG. 1 showing a first shield and a second shield in a retracted state; and

FIG. 4 is a side view of the rotary cutter of FIG. 1 showing the side opposite the side shown in FIG. 3;

FIG. 5 is a side view of the rotary cutter of FIG. 1 showing the first shield in an extended state and the second shield in a retracted state;

FIG. 6 is a side view of the rotary cutter of FIG. 1 showing the first shield in a retracted state and the second shield in an extended state;

FIG. 7 is an exploded side view of the rotary cutter of FIG. 1;

FIG. 8 is an exploded side view of the rotary cutter of FIG. 1 showing the side opposite the side shown in FIG. 7;

FIG. 9 is an exploded perspective view of a blade holder and a hub cap in accordance with various embodiments of these teachings;

FIG. 10 is a top-down view of the first actuation mechanism, the second actuation mechanism, the rotary blade and the hub cap of the rotary cutter of FIG. 1;

FIG. 11 is a side view of the first actuation mechanism of the rotary cutter of FIG. 1;

FIG. 12 is a perspective side view of the first side of the body of the rotary cutter of FIG. 1;

FIG. 13 is an elevational side view of one embodiment of a rotary cutter in accordance with various embodiments of these teachings;

FIG. 14 is a side view of the rotary cutter of FIG. 13 showing the side opposite the side shown in FIG. 13;

FIG. 15 is a side view of the rotary cutter of FIG. 13 showing the first shield and the second shield in a retracted state;

FIG. 16 is a side view of the rotary cutter of FIG. 13 showing the side opposite the side shown in FIG. 15 and further showing the first shield and the second shield in a retracted state;

FIG. 17 is a side view of the rotary cutter of FIG. 13 showing the first shield in an extended state and the second shield in a retracted state;

FIG. 18 is a side view of the rotary cutter of FIG. 13 showing the first shield in a retracted state and the second shield in an extended state;

FIG. 19 is an exploded side view of the rotary cutter of FIG. 13;

FIG. 20 is an exploded side view of the rotary cutter of FIG. 13 showing the side opposite the side shown in FIG. 20;

FIG. 21 is an exploded perspective view of a blade holder and a hub cap in accordance with various embodiments of these teachings;

FIG. 22 is a top-down view of the first actuation mechanism, the second actuation mechanism, the rotary blade and the hub cap of the rotary cutter of FIG. 13;

FIG. 23 is a side view of the first actuation mechanism of the rotary cutter of FIG. 13;

FIG. 24 is a perspective side view of the first side of the body of the rotary cutter of FIG. 13;

FIG. 25 is an elevational side view of one embodiment of a rotary cutter in accordance with various embodiments of these teachings;

FIG. 26 is a side view of the rotary cutter of FIG. 25 showing the side opposite the side shown in FIG. 25;

FIG. 27 is a side view of the rotary cutter of FIG. 25 showing the shield in a retracted state;

FIG. 28 is a side view of the rotary cutter of FIG. 25 showing the side opposite the side shown in FIG. 27;

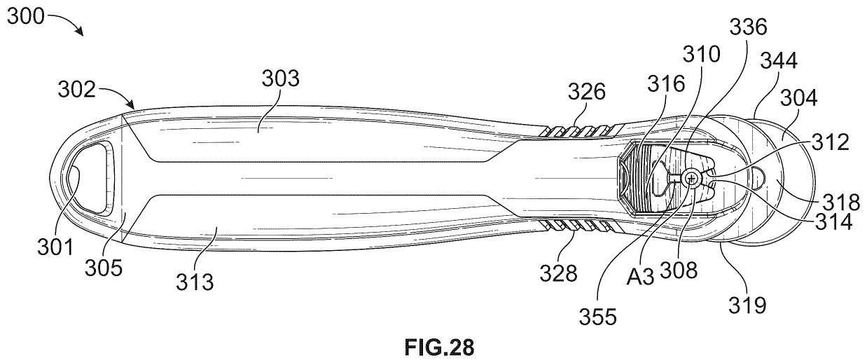

FIG. 29 is an exploded side view of the rotary cutter of FIG. 25;

FIG. 30 is an exploded side view of the rotary cutter of FIG. 31 showing the side opposite the side shown in FIG. 29;

FIG. 31 is an exploded perspective view of a blade holder and a hub cap in accordance with various embodiments of these teachings.

FIG. 32 is a top-down view of the actuation mechanism the rotary blade and the hub cap of the rotary cutter of FIG. 25;

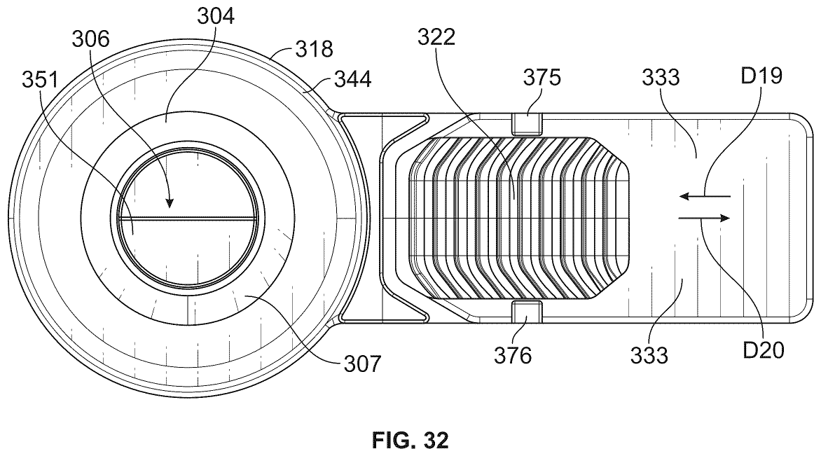

FIG. 33 is a side view of the actuation mechanism of the rotary cutter of FIG. 25;

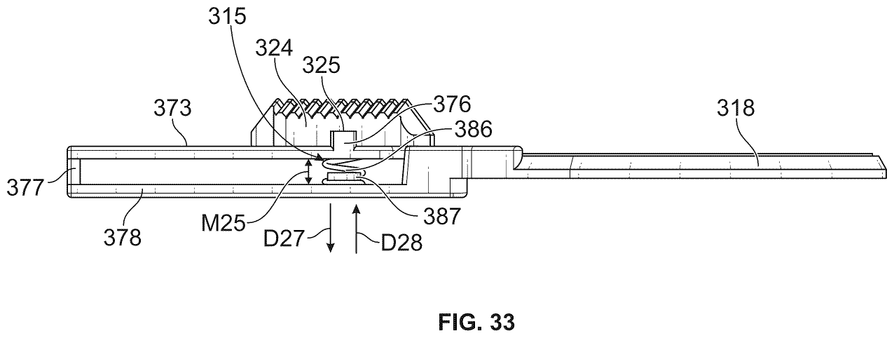

FIG. 34 is a perspective side view of the first side of the body of the rotary cutter of FIG. 25;

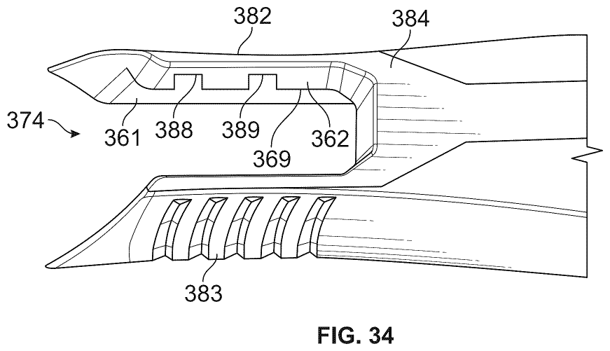

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, pursuant to these various embodiments, a rotary cutter or cutter with an easy-to-use safety feature is described herein. In one illustrative embodiment, the device is a handheld rotary cutter with a fully or partially retractable shield. In some approaches, the rotary cutter has a body with a rear end and a forward end that includes a blade holder configured to receive a rotary blade having an edge. By some approaches, the rotary cutter further includes one or more movable shields.

In one exemplary embodiment, the rotary cutter includes a first shield slidably connected to the body and configured to move between a first retracted position and a first extended position. In yet another configuration, the rotary cutter includes both a first shield and a second shield, where the second shield also is slidably connected to the body and configured to move between a second retracted position and a second extended position. When the first shield of the rotary cutter is in the first extended position it extends beyond a first portion of the edge of the rotary blade and wherein when the second shield is in the second extended position the second shield extends beyond a second portion of the edge of the rotary blade different than the first portion of the rotary blade.

Though the shields are described herein as being in a retracted and extended position, it should be understood that when the shields are disposed in their fully extended position, the rotary blade may be considered disposed in its own fully retracted or covered position due to the relationship that exists between the shields and the rotary blade. Likewise, when the shields are disposed in their fully retracted position, the rotary blade may be considered disposed in its fully extended or exposed position. Furthermore, when the shields are disposed such that one of the shields is retracted and the other shield is extended, the rotary blade may be considered partly exposed and partly retracted. More particularly, with one shield extended and one shield exposed the portion of the rotary blade opposite the retracted shield may be considered the retracted portion of the rotary blade and the portion of the rotary blade opposite the extended shield may be considered the extended portion of the rotary blade.

In one aspect, a rotary cutter may include a body with a rear end and a forward end with a blade holder for receiving a rotary blade with an edge and a pair of shields. By one approach, the rotary cutter includes a first shield and a second shield individually slidably connected to the body, wherein when the first shield is in the first extended position it extends beyond a first portion of the edge of the rotary blade and when the second shield is in the second extended position the second shield extends beyond a second portion of the edge of the rotary blade different than the first portion of the rotary blade. In use, when the first shield is moved from the first extended position to the first retracted position it typically exposes the first portion of the edge of the rotary blade, and similarly, when the second shield is moved from the second extended position to the second retracted position it typically exposes the second portion of the edge of the rotary blade.

In some embodiments, the shields include a semicircular portion configured to shield and seat a portion of the rotary blade while in the first extended position and a shaft that connects the shield to the body. When in use, the rotary cutter may be configured with one or both of the shields disposed in the retracted position. Further, in some configurations, the shield(s) may extend beyond and edge of the rotary blade by about 0.1 mm to about 2 mm. In some approaches, the shield may include a beaded edge that extends beyond a portion of the rotary blade when in the extended position.

In some configurations, the blade holder of the rotary cutter includes an axle shaft. For example, the axle shaft may include a first expanded end member and a second expanded end member with an axle shaft extending therebetween. By some approaches, the blade holder also includes a retaining clip slidably connected to the body of the rotary cutter and configured to engage with and bias a portion of the blade holder against the body of the rotary cutter when in an extended position and to disengage with and unbias the blade holder from against the body of the rotary cutter while in a retracted position.

In some approaches, the first expanded end member of the axle shaft has a diameter that is less than an opening in the rotary blade and an opening in the body of the rotary cutter and the second expanded end member has a diameter that is greater than the opening in the rotary blade and the opening in the body of the rotary cutter. In this manner, the first expanded end member of the axle shaft can pass through the opening in the rotary blade and the opening in the body of the rotary cutter and the second expanded end member of the axle shaft cannot pass through the opening in the rotary blade or the opening in the body of the rotary cutter. Further, in some approaches, the retaining clip is configured to bias the blade holder against the body of the rotary cutter by engaging with the axle shaft. In some embodiments, the retaining clip engages with a groove in the axle shaft after the axle shaft is at least partially disposed in the opening of the body of the rotary cutter. In one illustrative approach, the retaining clip has a first prong with a first angled surface and second prong with a second angled surface that are configured to engage with the groove in the axle shaft and bias the blade holder against the body of the rotary cutter when the retaining clip is in a secured or extended position, wherein the groove is disposed in a straight line about a circumference of the axle shaft

In some embodiments, the rotary cutter further includes an ergonomic handle. For example, the body may include one or more cushioned, gripping, and/or grasping surfaces. By one approach, the body includes a first plurality of fins that may be disposed or formed on a grip. The body also may include a second plurality of fins positioned or disposed in the grip. Further, the second plurality of grip fins may be disposed or positioned opposite of the first plurality of grip fins. By some approaches, the grips include a repeating pattern of valleys.

In another aspect, the rotary cutter includes a body having a rear end and a forward end, the forward end including a blade holder and configured to receive a rotary blade having an edge. The rotary cutter may further include a shield slidably connected to the body and configured to move between a retracted position and an extended position. In this manner, when the shield is in the extended position it extends beyond the edge of the rotary blade. Further, in some approaches, the shield may be comprised of one or more sections, which may be independently movable relative to one another and to a remainder of the rotary cutter.

In yet another aspect, a rotary cutter has a body with a blade holder configured to receive a rotary blade having an edge and a first shield slidably connected to a first actuator grip. The first actuator grip is configured to move the first shield, such as between a first retracted position and a first extended position. Further, the rotary cutter also may include a second shield slidably connected to a second actuator grip that is configured to move the second shield, such as between a second retracted position and a second extended position. Advantageously, when the first shield of the rotary cutter is in the first extended position it typically extends beyond a first portion of the edge of the rotary blade and when the second shield is in the second extended position the second shield typically extends beyond a second portion of the edge of the rotary blade different than the first portion of the rotary blade.

In still yet another aspect, the application provides a rotary cutter with a blade holder that includes an axle shaft configured to receive a rotary blade. The rotary cutter also includes a retaining clip slidably connected to the body of the rotary cutter and configured to engage with the blade holder when in a secured or extended position and to disengage with the blade holder when in an unsecured or retracted position. The rotary cutter also may include a shield slidably connected to an actuator grip that is configured to move the shield between a first position where the shield extends beyond the edge of the rotary blade and a second position and wherein the shield does not extend beyond the edge of the rotary blade.

The rotary cutter may be formed of a variety of materials. In some embodiments, the body is composed of a plastic material, such as, e.g., an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others. In addition, in some configurations, the grips are composed of a rubber material, such as, e.g., a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), and/or a Hydrogenated Nitrile (HNBR), among others. In yet other configurations, the grips are composed of a plastic material, such as, e.g., of a Thermoplastic Elastomer (TPE) and/or a Thermoplastic Rubber (TPR), among others. In some embodiments, the rotary blade is composed of, e.g., one of steel, such as a stainless steel, and/or a titanium bonded steel, among others. While the rotary cutter may have a generally flat or straight blade, it also may include one of a pinking rotary blade, a chenille rotary blade, a slash cutter rotary blade, a skip-cut rotary blade, scallop rotary blade, or a wave rotary blade, among many other optional designs.

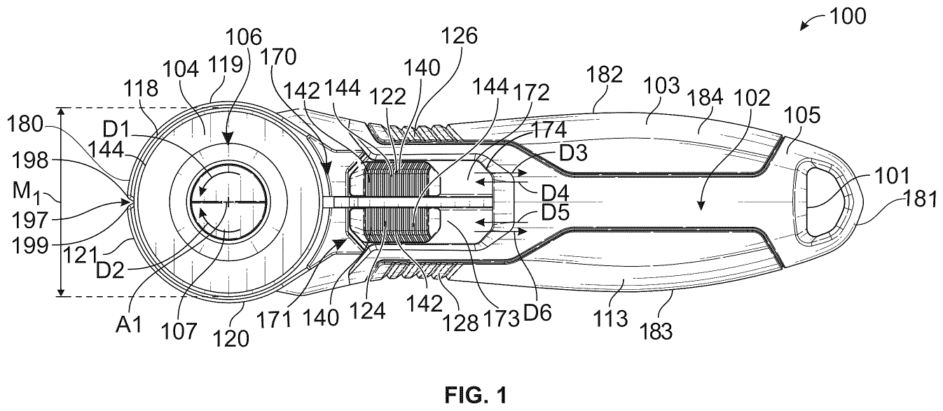

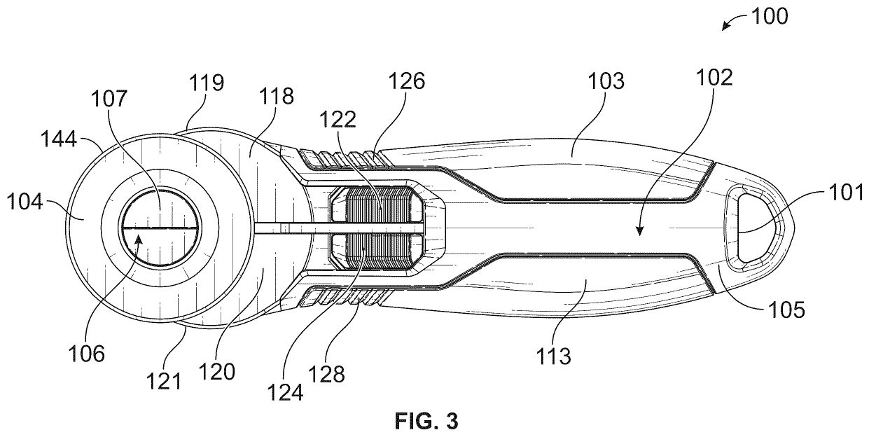

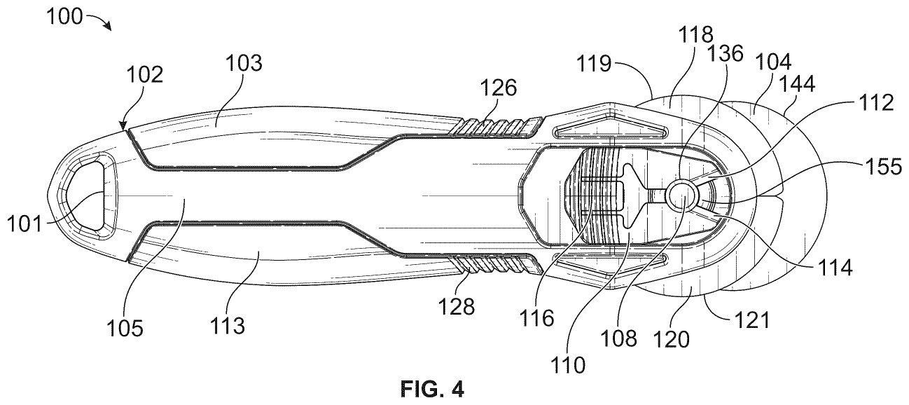

These and other benefits may become clearer upon making a thorough review and study of the following detailed description. Referring now to the drawings, and, in particular, to FIG. 1, where an illustrative rotary cutter 100 that is compatible with many of these teachings is presented. More particularly, FIGS. 1-9 illustrate one embodiment of a rotary cutter 100 having a forward end 180, a rear end 181, a top surface 182, a bottom surface 183, a first side 184 and a second side 185. The rotary cutter 100, in some embodiments, is generally comprised of a handle 102, a first actuation mechanism 170, a second actuation mechanism 171, a blade holder 106, a retaining clip 110, and a rotary blade 104.

As shown, the handle 102 of the rotary cutter 100 has body 105 that has a generally oblong shape. The body 105 of the handle 102 can be made from a variety of materials that are strong and durable. By some approaches, the body 105 of the handle 102 is comprised of a plastic material, such as, e.g., an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some embodiments, the handle 102 also has a first grip 103 that extends at least partially along the first side 184 of the handle, the top surface 182 of the handle 102, and the second side 185 of the handle 102. The handle 102 also may include a second grip 113 that extends at least partially along the first side 184 of the handle 102, the bottom surface 183 of the handle 102, and the second side 185 of the handle 102.

The first grip 103 and the second grip 113 can be formed of a variety of materials, including those that provide an additional grip or traction to a user's hand when the user is grasping the handle 102. In some embodiments, the first grip 103 and the second grip 113 are formed of a rubber material. More particularly, the first grip 103 and the second grip 113 may be formed of, for example, a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), and/or a Hydrogenated Nitrile (HNBR), among others. In another approach, the first grip 103 and the second grip 113 are formed of a plastic material such, e.g., a Thermoplastic Elastomer (TPE) and/or a Thermoplastic Rubber (TPR), among others.

In some configurations, the first grip 103 includes a first set or plurality of grip fins 126 located along the top surface 182 of the handle 102 and the second grip 113 has a second set or plurality of grip fins 128 located along the bottom surface 183 of the handle 102. In some configurations, the grip fins 126, 128 are disposed upon only a portion of the surface area of the grips. As shown in FIG. 1, the grip fins 126, 128 may be disposed where a thumb or finger is often manipulating during usage and the grips 102, 113 may have a smooth surface where a palm of the hand is more often exposed. To further provide an ergonomic configuration, the handle 102 may have a slightly pinched or narrowed section in the middle of the rotary cutter 100 and may have a wider section at an end of the handle 102 that is more often adjacent a palm of a user's hand when in use.

In some embodiments, the set of first grip fins 126 and the set of second grip fins 128 provide additional traction for the user when the user is grasping the handle 102 of the rotary cutter 100. In addition, the material of the grips themselves may provide increased grip for users.

The handle 102 also may include an aperture 101 that extends through the body 105 of the rotary cutter 100 and is located proximate to the rear end 181 of the rotary cutter 100. In use, the aperture 101 may be employed to safely and securely store the rotary cutter 100 on any number of objects, such as, e.g., a hook or peg. The aperture 101 may also be used to insert any type of suitable fastener, such as, e.g., a carabiner, which permits the user to store the rotary cutter 100 on a number of objects. In this manner, the rotary cutter 100 may be easily and quickly removably coupled to, e.g., a strap or a loop.

In some approaches, the rotary cutter 100 further includes a first actuation mechanism 170 and a second actuation mechanism 171. The first actuation mechanism 170 typically includes a first shaft or first attachment portion 172, a first actuator grip 122, and a first shield 118. Likewise, the second actuation mechanism 172 typically includes a second shaft or second attachment portion 173, a second actuator grip 124, and a second shield 120.

In some embodiments, the first shaft 172 and the first shield 118 of the first actuator mechanism 170 are formed from a single piece of material, such that the first shaft 172 and the first shield 118 are integrally connected to one another. In some configurations, the first actuator grip 122 is discrete from, but coupled to, the first shaft 172. In this manner, movement of the first actuator grip 122 in either direction D4 or D5 induces a corresponding movement in direction D4 or D5 of the respective first shaft 172 and the respective first shield 118.

Likewise, the second shaft 173 and the second shield 120 of the second actuator mechanism 171 are typically formed from a single piece of material, such that the second shaft 173 and the second shield 120 are integrally connected to one another. In some configurations, the second actuator grip 124 is discrete from, but coupled to the second shaft 173. In this manner, movement of the second actuator grip 124 in either direction D6 or D7 induces a corresponding movement in direction D6 or D7 of the respective second shaft 173 and the respective second shield 120.

In other embodiments, one or more of the shafts, the actuator grip, or the shield of one or more actuation mechanisms are discrete elements that are not formed from a single piece of material. In this manner, such discrete elements are coupled to each other to form the actuator mechanisms described herein.

In another embodiment, each one of the shafts, the actuator grip, and the shield are integrally connected to one another, such that they are not discrete elements, such as by being formed from a single piece of material, being adhered together, or being welded together.

In some embodiments, a manner of intermittently locking or providing a stable resting position for the first actuation mechanism 170 and the second actuation mechanism 171 is provided. This may be configured via one or more of corresponding geometry, stops, and/or biasing or detent mechanisms. In one illustrative embodiment, the stable or resting positions of the actuation mechanisms may employ a detent mechanism 115. In such an approach, the actuation mechanisms 170, 171 may be configured such that when the first actuation mechanism 170 and the second actuation mechanism 171 are slidably actuated relative to the body 105 they have a stable resting or locking position that keeps the first actuation mechanism 170 and the second actuation mechanism 171 in position until further manual manipulation thereof Accordingly, a user may utilize the rotary cutter 100 without concern that the actuation mechanisms 170, 171 may inadvertently move positions.

By one approach, the actuation mechanisms have one or more extensions or projections configured to mate with one or more corresponding geometries of the remainder of the rotary cutter 100. For example, the first actuation mechanism 170 can have a first projection 175 located on the first shaft 172 and the second actuation mechanism 171 can have a second projection 176 located on the second shaft 173. The first actuation mechanism 170 can also include a first lower shaft 178 that is connected to the first shaft 173 via a sidewall 177 that extends between the terminal end of the first shaft 172 and the first lower shaft 178. The first actuation mechanism 170 can also include a detent mechanism 115. In some embodiments, the detent mechanism 115 is positioned between the first shaft 173 and the first lower shaft 178. The detent mechanism 115 may also include a spring 186. In such a configuration, the first end of the spring can be coupled to the first shaft 172 and the second end of the spring 186 can be coupled to a button 187 provided on the first lower shaft 178. The spring 186 can be configured to provide a biasing force on the first shaft 172 in direction D24, such that when the spring 186 is in its natural state it keeps the distance M22 between the first shaft 172 and the first lower shaft 178 such that the first shaft 173 sits flush with the first shield 120 of the first actuation mechanism 170.

In some approaches, the first side 184 of the body 105 of the rotary cutter 100 may also include one or more respective recesses 188,189. For example, the recesses 188, 189 may be disposed in a flange 162 extending from a sidewall 161 of the first side 184 of the body 105. The sidewall 161 and the flange 162 provided in the first side 184 of the body 105 provide a slidable path for which the first actuation mechanism 170 can slide back and forth along the cutout portion 174 in the first side 184 in the body 105. As illustrated, the recesses 188,189 provided along the slidable track are cut out from the flange 162, such that recesses 188,189 interrupt the generally smooth bottom surface 169 provided by the flange 162. As also illustrated, the recesses 188,189 provided along the flange 162 will have a shape such that the first projection 175 can enter the recesses 188,189.

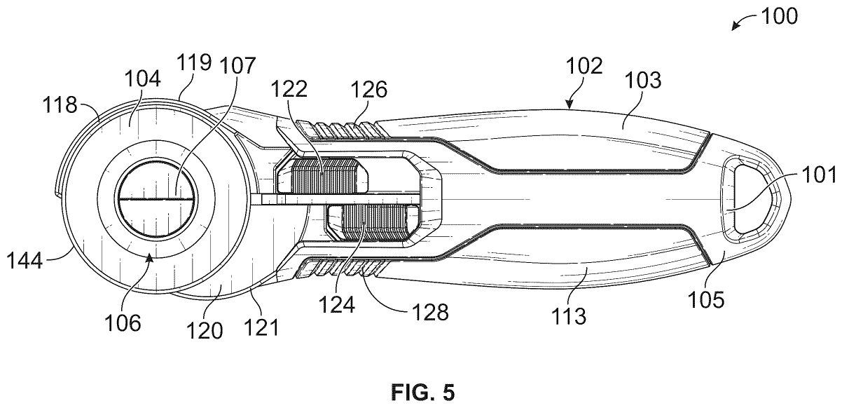

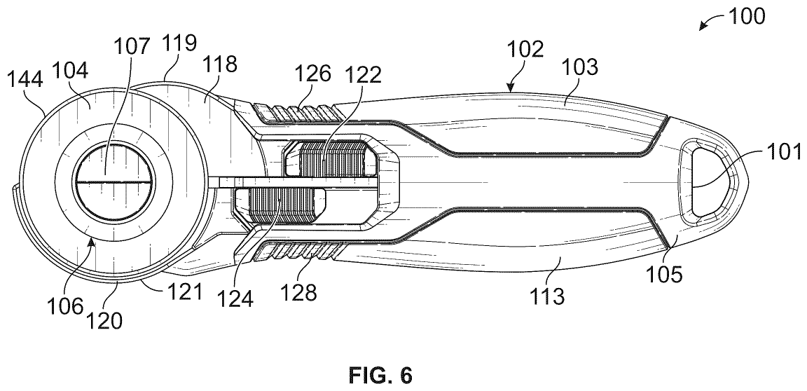

In the illustrated embodiment there are two recesses 188,189 that are positioned along the flange 162 at such positions that when the first projection 175 is received in the frontmost recess 188 the first shield 118 will be in the fully extended position (FIG. 5) and when the first projection 175 is received into the rearmost recess 189 the first shield 118 will be in the fully retracted position (FIG. 6).

Accordingly, if the user wants to move the first shield 118 from its fully extended position to its fully retracted position the user will first need to release the first projection 175 from the frontmost recess 188. To do so, sufficient force will need to be applied on the first actuator grip 122 in direction D23 to overcome the biasing force that the spring 186 is providing on the shaft 172 in direction D24. Once sufficient force has been applied in direction D23 it will cause the spring 186 to compress and cause the portion of the first shaft 172 located proximate to the first actuator grip 122 to begin flexing in direction D23 towards the first lower shaft 178. Once sufficient force has been applied in direction D23 the portion of the first shaft 172 with the first projection 175 will eventually flex in direction D23 enough, such that the first projection 175 will fully exit or sufficiently disengage from the frontmost recess 188. The user can then apply an axial force on the first actuator grip 122 in direction D20 (FIG. 1) which will cause the now released first actuation mechanism 170 including the first shield 118 to move in direction D20. As the first actuation mechanism 170 is moved in direction D20 the spring 186 will remain compressed either by the force being applied by the user or by coming into contact with the portion of the surface 169 of the flange 162 located between the frontmost recess 188 and the rearmost recess 189. The user will then continue applying an axial force on the first actuator grip 122 in direction D20 until the first projection 175 passes over the rearmost recess 189 in the flange 162 where the still compressed spring 186 will immediately bias the first shaft 172 in direction D24, which will cause the first projection 175 to be received into the rearmost recess 189. The spring 186 will then keep the first actuation mechanism 170 including the first shield 118 in the fully retracted state by biasing the first projection 175 against the rearmost recess 189 in the flange 162 provided in the body 105. Furthermore, as the first projection 175 is being biased in the rearmost recess 189 the first projection 175 will prevent the movement of the first actuation mechanism 170 in either direction D3 or D4 (FIG. 1) because the first projection 175 will come into contact with the sides of the rearmost recess 189 if the first actuation mechanism 170 is attempted to be moved in direction D3 or D4.

Then if the user wants to move the first shield 118 from its fully retracted position back to its fully extended position the user will need to release the first projection 175 from the rearmost recess 189. To do so, sufficient force will need to be applied on the first actuator grip 122 in direction D23 to overcome the biasing force that the spring 186 is providing on the shaft 172 in direction D24. Once sufficient force has been applied in direction D23 it will cause the spring 186 to compress and cause the portion of the first shaft 172 located proximate to the first actuator grip 122 to begin flexing in direction D23 towards the first lower shaft 178. Once sufficient force has been applied in Direction D23 the portion of the first shaft 172 with the first projection 175 will eventually flex in direction D23 enough, such that the first projection 175 will fully exit or sufficiently disengage from the rearmost recess 189. The user can then apply an axial force on the first actuator grip 122 in direction D19 (FIG. 1) which will cause the now released first actuation mechanism 170 including the first shield 118 to also move in direction D19. As the first actuation mechanism 170 is moved in direction D19 the spring 186 will remain compressed either by the force being applied by the user or by coming into contact with the portion of the surface 169 of the flange 162 located between the rearmost recess 189 and the frontmost recess 188. The user will then continue applying an axial force on the first actuator grip 122 in direction D19 until the first projection 175 passes over the frontmost recess 188 in the flange 162 where the still compressed spring 186 will immediately bias the first shaft 172 in direction D24, which will cause the first projection 175 to be received into the frontmost recess 188. The spring 186 will then keep the first actuation mechanism 170 including the first shield 118 in the fully extended state by biasing the first projection 175 against the frontmost recess 188 in the flange 162 provided in the body 105.

As will appreciated, if the user wants to move the second shield 120 from its fully extended position (FIG. 6) to its fully retracted position (FIG. 5) the user will perform similar steps as discussed above relative to the first actuation mechanism 170 but execute them on the corresponding components of the second actuation mechanism 171. This will cause a similar interaction between the second projection 176 provided on the second shaft 173 of the second actuation mechanism 171 and the frontmost and rearmost recess 189 of a flange 162 that corresponds to the one discussed above except that it is located along the second side 183 of the first side 184 of the body 105.

According to one aspect, the first actuation mechanism 170 and the second actuation mechanism 171 can be formed of a variety of materials. According to another aspect, the first actuation mechanism 170 and the second actuation mechanism may be, e.g., formed from a plastic material, such as, e.g., an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some configurations, the first actuation mechanism 170 includes a first actuator grip 122 that is formed along the top surface of the first shaft 172 and the second actuation mechanism 171 includes a second actuator grip 124 that is formed along the top surface of the second shaft. The first actuator grip 122 and the second actuator grip 124, in some embodiments, have a textured surface, such as a repeating pattern of valleys 140. By some approaches, the valleys 140 have a first angular side 142 and a second angular side 144 that meet to form a lowermost portion thereof. Advantageously, the repeating pattern included along the surfaces of the first actuator grip 122 and the second actuator grip 124 provides increase traction between this surface and a user's finger or thumb.

As noted, the first actuation mechanism 170 also has a first shield 118 associated therewith and the second actuation mechanism 171 has a second shield 120 associated therewith. The first shield 118 typically extends from the first shaft 172 of the first actuation mechanism 170 and the second shield 120 typically extends from the second shaft 173 of the second actuation mechanism 173. The first shield 118 and the second shield 120 both having a generally semicircular shape, such that when the first shield 118 and the second shield 120 are positioned adjacent to one another they form a generally circular shape.

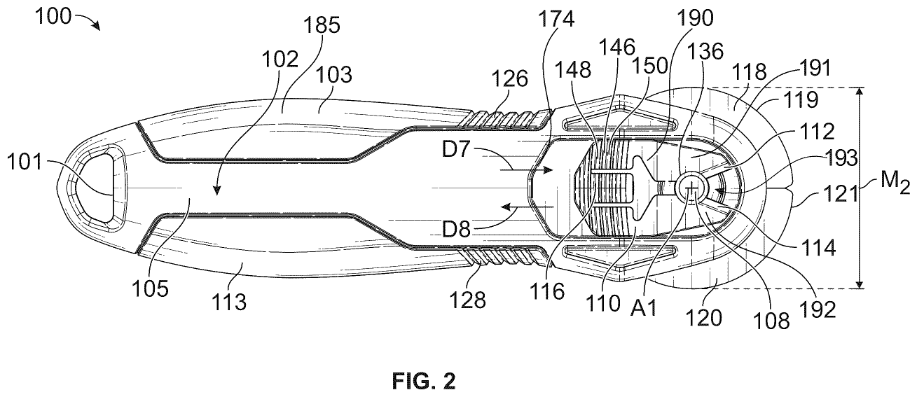

By some approaches, when the first shield 118 and the second shield 120 are positioned adjacent to one another the generally circular shape formed by the first shield 118 and the second shield 120 has a diameter M2 (see FIG. 2) which is greater than the diameter M1 of the rotary blade 104 (see FIG. 1), such that when the first shield 118 and the second shield 120 are positioned adjacent to one another and overlay the rotary blade 104, the edge 119 of the first shield 118 and the edge 121 of the second shield 120 will extend beyond the edge 144 of the rotary blade 104. Advantageously, such a configuration may prevent the edge 144 of the rotary blade 104 from coming into accidental contact with and/or accidentally causing damage to an object or a user when the rotary blade 104 is not in use. In addition to preventing unintentional injury or accidental usage of the rotary blade 104, it also helps retain the blade in good working order so that it doesn't become dull or damaged.

In addition, by having the first shield 118 and the second shield 120 independently actuated, the rotary cutter 100 may be utilized in a number of different configurations. More particularly, the rotary cutter 100 is capable of being used to cut a material, when one or both of the shields 118, 120 are in their retracted positions. In some circumstances, this enables the rotary cutter 100 to be used in a right- or left-handed configuration. Furthermore, as described above, the notch 197 permits a user to cut threads or other small items even without one or both of the shields being retracted.

By one approach, the diameter M2 of the first shield 118 and the second shield 120 is between about 0.1 mm to 2 mm greater than the diameter M1 of the rotary blade 104. In yet another approach, the difference in the diameter of M2 and M1 is between about 0.25 mm to 1 mm. Further, in some configurations, the diameter M1 of the rotary blade 104 is about 45 mm and the diameter M2 of the first shield 118 and the second shield 120 is between about 45.1 mm and 47 mm.

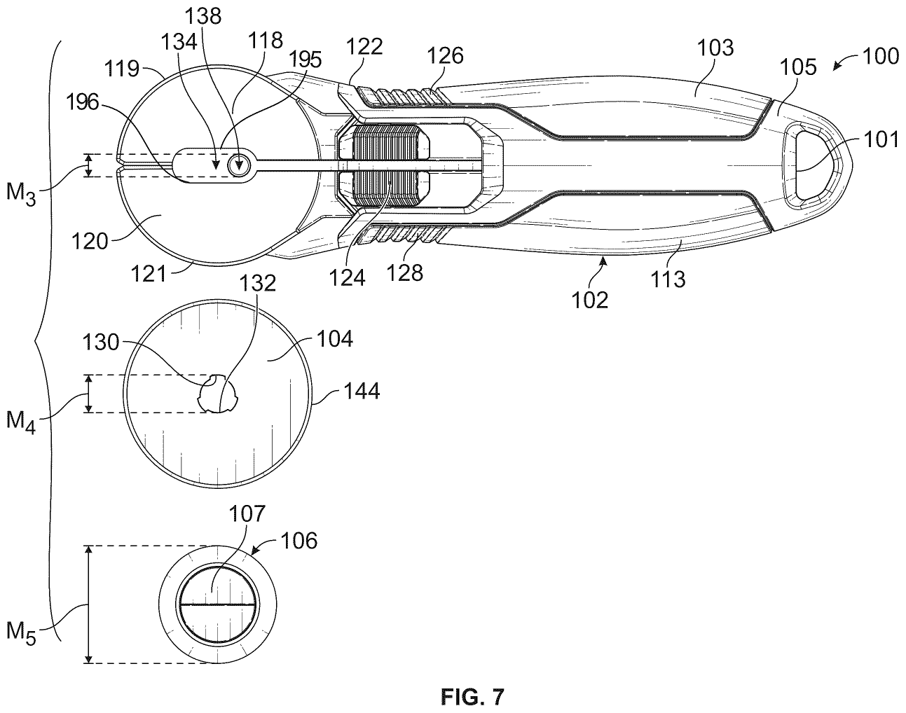

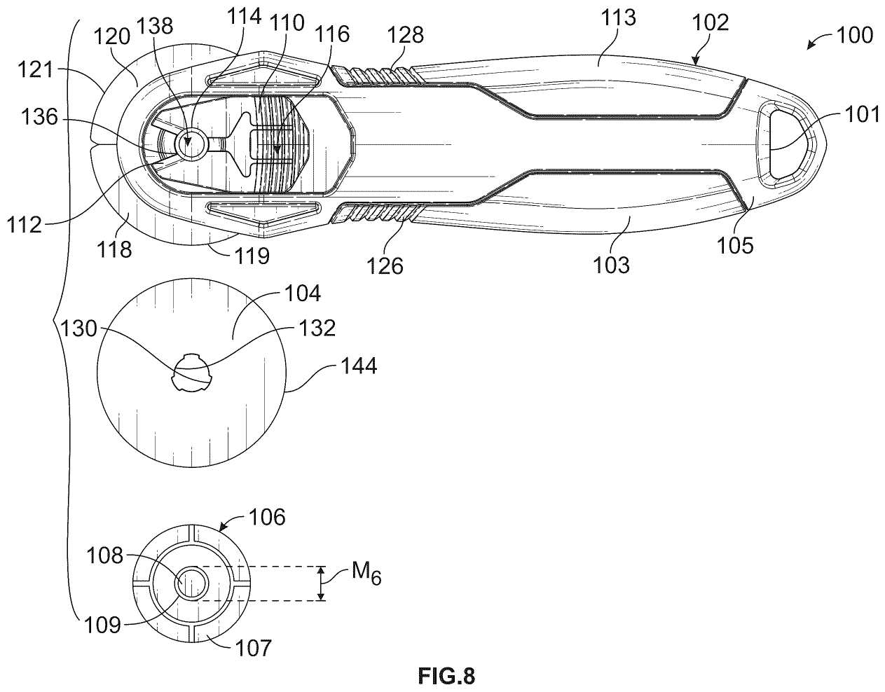

In some approaches, the first shield 118 and the second shield 120 each have respective beaded edges 119, 121 and respective cutout portions 195,196. As shown in FIG. 7, the respective cutout portions 195, 196 form an opening 134 between the first shield 118 and the second shield 120 that is configured to accommodate an axle shaft or blade retention member 111 of the blade holder 106 (see, e.g., FIG. 8) as the first shield 118 and the second shield 120 are moved between their respective retracted and extended positions.

In some embodiments, the first shield 118 and the second shield 120 also may have a crevasse 197 formed therein. In one illustrative embodiment, the crevasse 197 is formed by respective first notch 198 and a respective second notch 199 formed in respective shields, such as at the beaded edges 119, 121. When the first shield 118 and the second shield 120 are in their fully extended state the first notch 198 and the second notch 199 align with one another and form a crevasse 197 through the first shield 118 and the second shield 120 such that the edge 144 of the rotary blade 104, which is located adjacent to the crevasse 197, can come into contact with and cut an object that is small enough to fit within the crevasse 197, such as, e.g., a piece of paper, wire, or thread. In this manner, the rotary cutter 100 may be used to snip or cut, for example, a thread from a piece of material without manually engaging one of the actuation mechanisms 170, 171 and moving one of the associated shields 118, 120.

As suggested above, in some configuration, the first shield 118 has a first or extended position in which the first shield 118 shields, seats, nests, guards, overhangs or abuts with the edge 144 of a first portion of the rotary blade 104 and a second or retracted position in which the first shield 118 does not shield, seat, or abut at least a portion of the edge 144 of the first portion of the rotary blade 104. Likewise, the second shield 120 having a first or extended position in which the second shield 120 shields, seats, nests, guards, overhangs or abuts the edge 144 of a second portion of the rotary blade 104 and a second or retracted position in which the second shield 120 does not shield, seat, abut at least a portion of the edge 144 of the second portion of the rotary blade 104.

In operation, to move the first shield 118 from the first or extended position (see FIG. 5) to the second or retracted position (see FIG. 6) a user will need to actuate the first actuation mechanism 170 in direction D3 (see, e.g., FIG. 1). During typical use, a user will place their finger on the first actuator grip 122 and then apply an inward and then generally lateral force on the first actuator grip 122 in direction D3. More particularly, a user typically presses the actuator grip 122 inward toward a rear or second side 185 of the rotary cutter 100. Then, when the user applies the generally lateral force on the first actuator grip 122 in direction D3 it will cause both the shaft 172 and the first shield 118 to move in direction D3 in accordance with the movement of the first actuator grip 122 due to the first shield 118 and the first shaft 172 being coupled together or integrally formed from the same piece of material and the first actuator grip 122 being coupled to the shaft 172.

Likewise, when a user wants to move the first shield 118 from the second or retracted position (see FIG. 6) to the first or extended position (see FIG. 5) the user will need to actuate the first actuation mechanism 170 in direction D4. Typically, the user will place their finger on the first actuator grip 122 and then apply an inward and generally lateral force on the first actuator grip 122 in direction D4. When the user applies the generally lateral force on the first actuator grip 122 in direction D4 it will also cause the first shaft 172 and the first shield 118 to move in direction D4 in accordance with the movement of the first actuator grip 122 due to the first shield 118 and the first shaft 172 being coupled together or integrally formed from the same piece of material and the first actuator grip 122 being coupled to the first shaft 172.

To move the second shield 120 from the first or extended position (see FIG. 6) to the second or retracted position (see FIG. 5) a user will need to actuate the second actuation mechanism 171 in direction D5. To do so, a user will typically place their finger on the second actuator grip 124 and then apply an inward and a generally lateral force on the second actuator grip 124 in direction D5. When the user applies the generally lateral force on the second actuator grip 124 in direction D5 it will also cause the shaft 173 and the second shield 120 to move in direction D5 in accordance with the second actuator grip 124 because the second shield 120 and the second shaft 173 are coupled together or integrally formed from the same piece of material and the second actuator grip 124 is coupled to the second shaft 173.

Likewise, when a user wants to move the second shield 120 from the second or retracted position (see FIG. 5) to the first or extended position (see FIG. 6) the user will need to actuate the second actuation mechanism 171 in direction D6. Under normal operation, a user will typically put their finger on the second actuator grip 124 and then apply an inward and generally lateral force on the second actuator grip 124 in direction D6. When the user applies the inward and generally lateral force on the second actuator grip 124 in direction D6 it will also cause the second shaft 173 and the second shield 120 to move in direction D6 in accordance with the second actuator grip 124 due to the second shield 120 and the second shaft 173 being coupled together or integrally formed from the same piece of material and the second actuator grip 124 being coupled to the second shaft 173.

Further, as the embodiment of the rotary cutter 100 disclosed herein has a first actuation mechanism 170 including a first shield 118 that is responsible for shielding, seating or abutting the top half of the rotary blade 104 and a second actuation mechanism 171 that includes a second shield 120 that is responsible for shielding, seating or abutting the bottom half of the rotary blade 104, a user typically has the option to retract one or both of the first shield 118 and second shield 120 at any given time to expose more or less of the edge 144 of the rotary blade 104 to suit the needs of the user at that particular time.

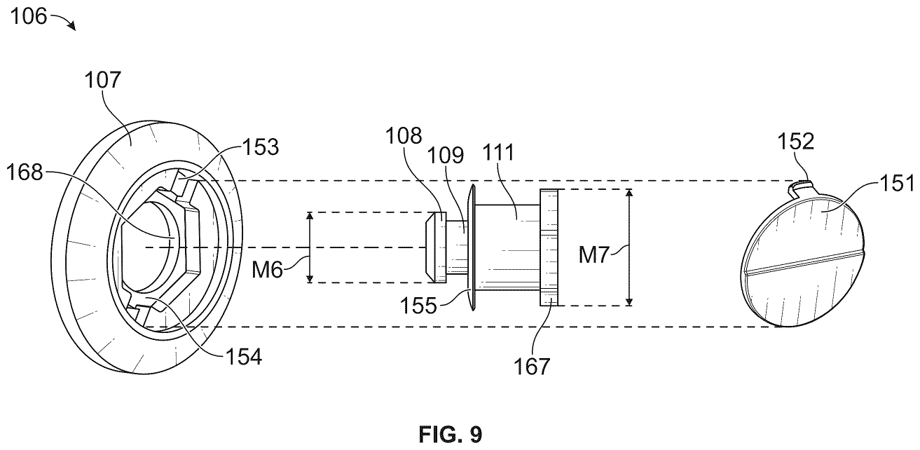

Positioned adjacent to the front end 180 of the rotary cutter 100 is a blade holder 106 (see, e.g., FIGS. 1 and 9) capable of receiving and rotationally coupling a rotary blade 104 to the handle 102. In this manner, the rotary blade 104 is capable of rotating about axis A1 in a first direction D1 and a second direction D2.

As shown in FIGS. 7 and 9, the blade holder 106, in one illustrative configuration, includes a hub cap 107 and an axle shaft 111. The axle shaft 111 includes a first expanded end member 167 and a second expanded end member 108 with a shaft 194 extending therebetween. The second expanded end member 108 of the axle shaft 111 has a diameter M6, which is smaller than an opening 132 in the rotary blade 104, which has a diameter M4. In addition, the body 105 of the rotary cutter may have an opening 138 with a diameter M3. In this manner, the second expanded end member 108 of the axle shaft 111 can pass through the opening 132 in the rotary blade 104. In addition, the second expanded end member 108 also may advance through the opening 138 of the body 105.

Further, the first expanded end member 167 of the axle shaft 111 has a diameter M7 that is larger than the opening 132 in the rotary blade 104 and the opening 138 extending through the body 105 of the rotary cutter, such that the first expanded end member 167 cannot pass through the opening 132 in the rotary blade 104 or the opening 138. In some embodiments, the axle shaft 111 further includes a groove 109 located proximate to the second expanded end member 108 of the axle shaft 111. Also, the blade holder 106 may include a washer. In some configurations, the washer 155 is configured to abut against the side of the groove 108 opposite the second expanded end member 108 and also may be configured to abut against the retaining clip 110 when the blade holder 106 has been installed and secured to the body 105 of the rotary cutter 100.

As shown in FIG. 9, in one illustrative approach, the hub cap 107 has a generally disk-like shape having a diameter M5 and includes an opening 168 and a seated portion 154 that is shaped like the first end member 167 of the axle shaft 111. Advantageously, the seated portion 154 of the hub cap 107 may be configured to engage with and retain the first end member 167 when the axle shaft 111 is inserted second expanded member 108 side first through the opening 168 of the hub cap 107. The hub cap 107 also typically includes a cover 151 that is generally circular in shape and flanges 152 disposed on or about its perimeter. By one approach, these are configured to engage with and be retained by notches 153 provided in the hub cap 107. In some embodiments, the manufacturer's name or other relevant information like the appropriately sized rotary blade 104 to use with the rotary cutter 100 may be placed on the hub cap cover 151.

In some configurations, the retaining clip 110 has a body 190 including a first prong 191 and a second prong 192 extending from the body 190. The first prong 191 having a first angled surface 112 and the second prong 192 having a second angled surface 114 with an opening 193 provided therebetween. The retaining clip 110 is slidably connected to the body 105 of the rotary cutter 100, such that a user can move the retaining clip 110 in a first direction D7 and a second direction D8 relative to the body 105 of the rotary cutter 100 by actuating the retaining clip 110 in direction D7 and D8 respectively.

As shown in FIG. 2, the retaining clip 110 further including a thumb grip 116 having a textured surface including a repeating pattern of ridges 146. By some approaches, the ridges 146 of the thumb grip 116 having a first angular side 148 and a second angular side 150 that meet to form a pinnacle of each of the ridges 146. Advantageously, the textured surface including the repeating pattern of ridges 146 provided on the thumb grip 116 may provide a user with additional traction when actuating the retaining clip in direction D7 and D8.

By some approaches, the retaining clip 110 may be comprised of a plastic material, such as, e.g., an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

When a rotary blade 104 is installed on the rotary cutter 100 it is held in place, in part, by an axle shaft 111 whose second end member 108 is received through the opening 132 in the rotary blade 104. Once the axle shaft 111 has been inserted through the opening 132 of the rotary blade 104, the axle shaft 111 will then be inserted through opening 138 in the body 105 of the rotary cutter 100. The axle shaft 111 will be inserted through the opening 138 of the body 105 until the groove 109 on the axle shaft 111 is at least partially protruding through the opening 138 in the body 105 of the rotary cutter 100.

In one illustrative configuration, the axle shaft 111 is secured to the body 105 of the rotary cutter 100 by the retaining clip 110. By some approaches, the retaining clip 110 engages with a groove 109 (FIG. 9) of the axle shaft 111 (which in some approaches is formed proximate to the second end member 108). The groove 109 of the axle shaft 111 is configured to be received between the first angled surface 112 of the first prong 191 and the second angled surface 114 of the second prong 192 (FIG. 2). In an exemplary approach, the retaining clip 110 is advanced into its secured position retaining the rotary blade 104, by advancing the axle shaft 111 into a channel 136 formed between the first prong 191 and the second prong 192. By some approaches, a user holds the hub cap 107 in place while advancing the thumb grip 116 of the retaining clip 110 toward the forward end 180 thereby advancing the prongs 191, 192 into position around the axle shaft 111. Also, in some embodiments, the angled surfaces 112, 114 of the prongs 191, 192 engage with the groove 109 on the axle shaft 111 to guide the axle shaft 111 into the channel 136.

As suggested above, a user applies sufficient force on the thumb grip 116 of the retaining clip 110 in direction D7 to force the groove 109 of the axle shaft 111 into position between the terminating ends of the first angled surface 112 and the second angled surface 114 and into the channel 136. As the size of the channel 136 formed between the first prong 191 and the second prong 192 of the retaining clip 110 is large enough to receive the groove 109 of the axle shaft 111 but smaller than the diameter M6 of the second retaining member 108, the axle shaft 111 is secured to the body 105 at one end by the second retaining member 108 that is captured by or rests against the retaining clip 110. In addition, at the other end of the axle shaft 111, it is retained by the first retaining member 167 (FIG. 9) that is also rotatably coupling the rotary blade 104 to the body 105 of the rotary cutter 100.

In one approach, the body 102 has a cutout 174 (FIG. 2) formed therein on a side thereof opposite the actuation mechanisms. In one embodiment, the cutout 174 is sized to permit the retaining clip 110 to be moved in a lateral direction therein, thereby permitting the retaining clip 110 to engage and disengage a secure connection between the blade holder 106 and the prongs 191, 192. In addition, in some configurations, the cutout 174 is sized to prevent the retaining clip from being easily separated from the body 102. Accordingly, it is sized just slightly larger than the retaining clip 110. Indeed, while a user may easily remove the blade 104 once the retaining clip 110 is moved to a release position, the retaining clip 110 itself is not easily released or separated from the body 102 as it is retained in the cutout 174, which is sized to permit lateral movement of the retaining clip 110 but not to permit easy, manual removal of the retaining clip 110 from the body 102. In yet another embodiment, the cutout 174 may have an upper ledge or flange at an upper end thereof to further prohibit the retaining clip 110 from being removed from the body 102.

Advantageously, the rotary cutter 100 described herein allows a user to replace the rotary blade 104 with a new rotary blade 104 when desired. This allows the user to replace a rotary blade 104 whose edge 144 has become dull, damage, or dirty and/or to swap out the current rotary blade 104 for a different style of rotary blade 104 that is more suitable for cutting a particular material or for providing the user with a particular effect when cutting a material. Further, by having a replaceable blade in the rotary cutter 100, the handle 102 may be reused with other blades after the initial rotary blade 104 has become worn out.

To remove the rotary blade 104 currently coupled with the rotary cutter 100, a user will typically place the first shield 118 and the second shield 120 in their extended positions to ensure that the edge 144 of the rotary blade 104 that is currently coupled to the rotary cutter 100 is covered during the removal process. The user then typically actuates the thumb grip 116 of the retaining clip 110 in direction D8 with sufficient force to cause the axle shaft 111 to become dislodged from the retaining clip. More particularly, the groove 109 of the axle shaft 111 becomes disengaged from the channel 136 and between the first angular surface 112 and the second angular surface 114 of the respective first prong 191 and second prong 192 of the retaining clip 110.

In this manner, the user can then continue to actuate the thumb grip 116 of the retaining clip 110 in direction D8 until no portion of the axle shaft 111 remains coupled to the retaining clip 110. The user may then simply slide the axle shaft 111 out through the opening 138 in the body 105 of the rotary cutter 100 and then remove the utility blade 104 that is being replaced by passing the utility blade 104 over the axle shaft 111 in the direction of the second end member 108.

Then to install a new rotary blade 104 onto the rotary cutter 100, a user will first ensure that the retaining clip 110 is in an unlocked state by actuating the thumb grip 216 in direction D8 until retaining clip 110 is not blocking the opening 138 in the body 105. The user can then insert the first expanded end member 108 of the axle shaft 111 through the opening 132 in a new rotary blade 104. Then, once the first expanded end member 108 of the axle shaft 111 has been inserted through the opening 132 in the rotary blade the user will then insert the first expanded end member 108 of the axle shaft 111 through the opening 138 in the body 105 of the rotary cutter 100 until the groove 109 on the axle shaft 111 is at least partially extending through the opening 138 in the body 105. The user will then place the retaining clip 110 into a locked state by engaging the thumb grip 116 to advance the retaining clip 110 in direction D7 toward the axle shaft 111.

As the user advances the retaining clip 110 in direction D7, the groove 109 on the axle shaft 111 is typically received in the tapered opening 193 formed between the first prong 191 and the second prong 192 of the retaining clip 110. In one approach, the tapered opening 193 is defined, in part, by the first angular surface 112 of the first prong 191 and the second angular surface 114 of the second prong 192.

After the groove 109 of the axle shaft 111 has passed into the channel 136 of the retaining clip 110, the force that was being applied by the user on the first angular surface 112 and the second angular surface 114 is removed or reduced due to the passing of the axle shaft 111 into the channel 136. Once the force has been removed from the first angular surface 112 and the second angular surface 114 it typically causes the first prong 191 and the second prong 192 to return to their natural state by shifting slightly closer together, such that the distance between the first angular surface 112 and the second angular surface 114 adjacent to the channel 136 is less than the diameter of the groove 109 in the axle shaft 111.

Accordingly, the groove 109 of the axle shaft 111 typically remains secured in the channel 136 until a user applies sufficient force on the retaining clip 110 in direction D7 to force the axle shaft 111 out of the channel 136. In one configuration, the user supplies a sufficient force so that when the ends of the first angular surface 112 and the second angular surface 114 come in contact with the axle shaft 111 they are forced sufficiently far apart to allow the groove 109 of the axle shaft 111 to pass therebetween and release the axle shaft 111 from the channel 136.

Advantageously, the rotary cutter 100 can be used with a variety of rotary blades, such as the rotary blade 104 illustrated in FIG. 1. By some approaches, the rotary blade may include a generally straight or flat blade, a pinking rotary blade, a chenille rotary blade, a slash cutter rotary blade, a skip-cut rotary blade, scallop rotary blade, and/or a wave rotary blade, among others. In addition, the rotary blade 104 may be formed of a variety of material, such as, e.g., steel, stainless steel, and/or titanium bonded steel, among others. Likewise, the rotary cutter 100 and the rotary blade 104 can be configured in a variety of sizes and/or shapes. Further, the rotary cutter 100 is configured to receive rotary blades 104 having notches 130 about their central opening 132 along with rotary blades 104 having a more generally circular central opening 132.

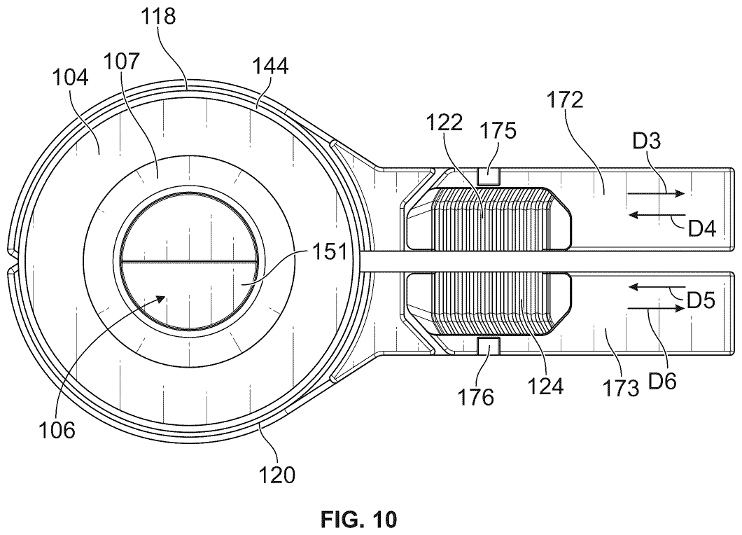

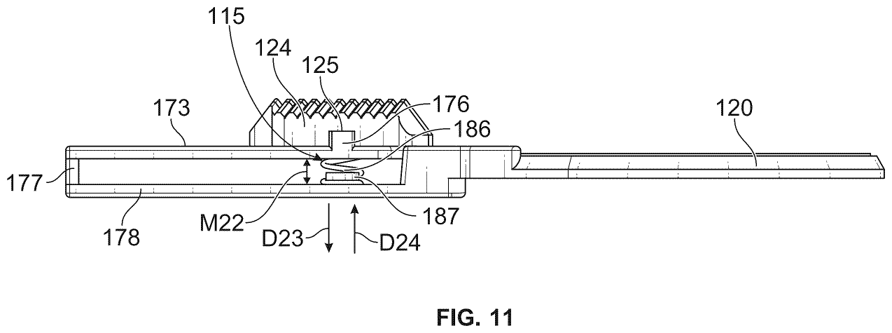

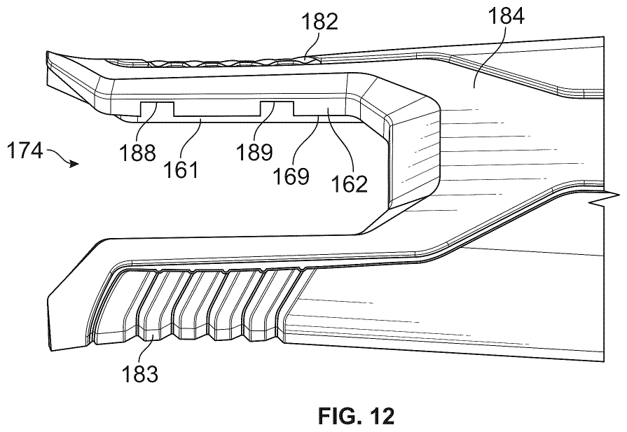

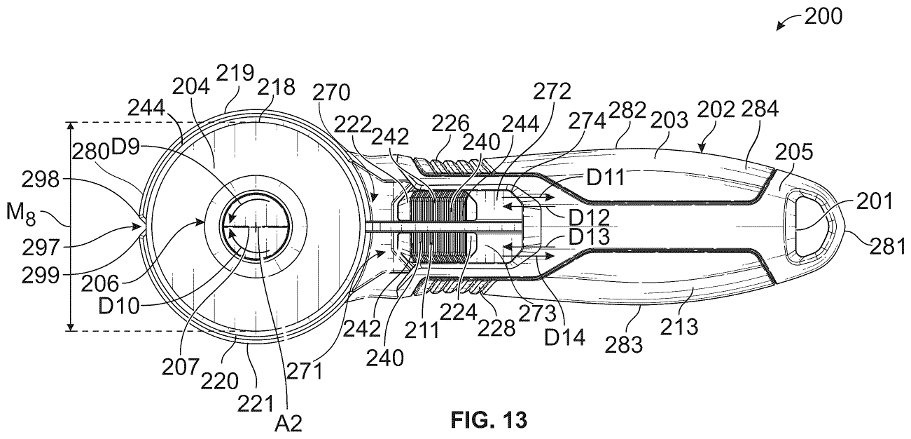

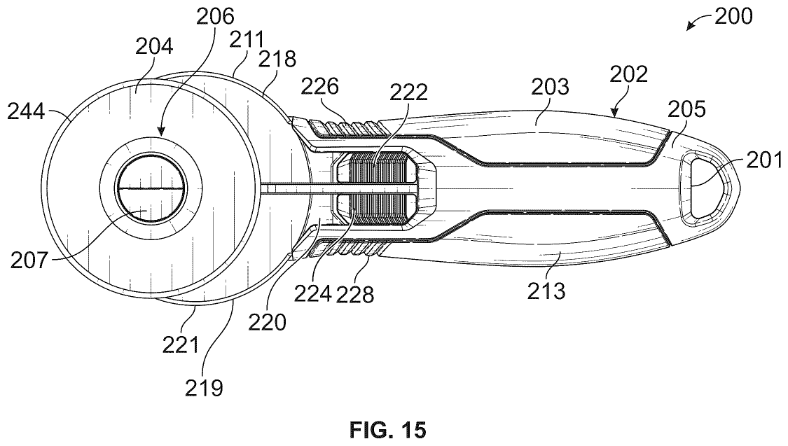

Turning to FIG. 13, an illustration of a rotary cutter 200 that is compatible with many of the teachings discussed herein is presented. More particularly, FIGS. 10-18 illustrate one embodiment of a rotary cutter 200 having a forward end 280, a rear end 281, a top surface 282, a bottom surface 283, a first side 284 and a second side 285. The rotary cutter 200, in some embodiments, is generally comprised of a handle 202, a first actuation mechanism 270, a second actuation mechanism 271, a blade holder 206, a retaining clip 210, and a rotary blade 204.

As shown, the handle 202 of the rotary cutter 200 has body 205 that has a generally oblong shape. The body 205 of the handle 202 can be made from a variety of materials that are strong and durable. By some approaches, the body 205 of the handle 202 is comprised of a plastic material, such as, e.g., an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some embodiments, the handle 202 also has a first grip 203 that extends at least partially along the first side 284 of the handle, the top surface 282 of the handle 202, and the second side 285 of the handle 202. The handle 202 also may include a second grip 213 that extends at least partially along the first side 284 of the handle 202, the bottom surface 283 of the handle 202, and the second side 285 of the handle 202.

The first grip 203 and the second grip 213 can be formed of a variety of materials, including those that provide an additional grip or traction to a user's hand when the user is grasping the handle 202. In some embodiments, the first grip 203 and the second grip 213 are formed of a rubber material. More particularly, the first grip 203 and the second grip 213 may be formed of, for example, a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), and/or a Hydrogenated Nitrile (HNBR), among others. In another approach, the first grip 203 and the second grip 213 are formed of a plastic material such, e.g., a Thermoplastic Elastomer (TPE) and/or a Thermoplastic Rubber (TPR), among others.

In some configurations, the first grip 203 includes a first set or plurality of grip fins 226 located along the top surface 282 of the handle 202 and the second grip 213 has a second set or plurality of grip fins 228 located along the bottom surface 283 of the handle 202. In some configurations, the grip fins 226, 228 are disposed upon only a portion of the surface area of the grips. As shown in FIG. 13, the grip fins 226, 228 are disposed where a thumb or finger is often manipulating during usage and the grips 202, 213 have a smooth surface where a palm of the hand is more often exposed. To further provide an ergonomic configuration, the handle 202 may have a slightly pinched or narrowed section in the middle of the rotary cutter 200 and may have a wider section at an end of the handle 202 that is more often adjacent a palm of a user's hand when in use.

In some embodiments, the set of first grip fins 226 and the set of second grip fins 228 provide additional traction for the user when the user is grasping the handle 202 of the rotary cutter 200. In addition, the material of the grips themselves may provide increased grip for users.

The handle 202 also may include an aperture 201 that extends through the body 205 of the rotary cutter 200 and is located proximate to the rear end 281 of the rotary cutter 200. In use, the aperture 201 may be employed to safely and securely store the rotary cutter 200 on any number of objects, such as, e.g., a hook or peg. The aperture 201 may also be used to insert any type of suitable fastener, such as, e.g., a carabiner, which permits the user to store the rotary cutter 200 on a number of objects. In this manner, the rotary cutter 200 may be easily and quickly removably coupled to, e.g., a strap or a loop.

In some approaches, the rotary cutter 200 further includes a first actuation mechanism 270 and a second actuation mechanism 271. The first actuation mechanism 270 typically includes a first shaft or first attachment portion 272, a first actuator grip 222, and a first shield 218. Likewise, the second actuation mechanism 272 typically includes a second shaft or second attachment portion 273, a second actuator grip 224, and a second shield 220.

In some embodiments, the first shaft 272 and the first shield 218 of the first actuator mechanism 270 are formed from a single piece of material, such that the first shaft 272 and the first shield 218 are integrally connected to one another, while the first actuator grip 222 is discrete from, but coupled to the first shaft 272, such that movement of the first actuator grip 222 in either direction D11 or D12 induces a corresponding movement in direction D11 or D12 of the respective first shaft 272 and the respective first shield 218.

Likewise, the second shaft 273 and the second shield 220 of the second actuation mechanism 271 may be formed from a single piece of material, such that the second shaft 273 and the second shield 220 are integrally connected to one another, while the second actuator grip 224 is discrete from, but coupled to the second shaft 273, such that movement of the second actuator grip 224 in either direction D13 or D14 induces a corresponding movement in direction D13 or D14 of the respective second shaft 273 and the respective second shield 220.

In other embodiments, one or more of the shafts, the actuator grip, or the shield of one or more actuation mechanisms are discrete elements that are not formed from a single piece of material. In this manner, such discrete elements are coupled to each other to form the actuation mechanisms described herein.

In another embodiment, each one of the shafts, the actuator grip, and the shield are integrally connected to one another, such that they are not discrete elements, such as by being formed from a single piece of material, being adhered together, or being welded together to form the actuation mechanism described herein.

In some embodiments, a manner of intermittently locking or providing a stable resting position for the first actuation mechanism 270 and the second actuation mechanism 271 is provided. This may be configured via one or more of corresponding geometry, stops, and/or a biasing or detent mechanism. In one illustrative embodiment, the stable or resting positions fo the actuation mechanism may employ a using a detent mechanism 215. In such an approach, the actuation mechanisms 270, 271 may be configured such that when the first actuation mechanism 270 and the second actuation mechanism 271 are slidably actuated relative to the body 205 they have a stable resting or locking position that keeps the first actuation mechanism 270 and the second actuation mechanism 271 in position until further manual manipulation thereof. Accordingly, a user may utilize the rotary cutter 200 without concern that the actuation mechanisms 270, 271 may inadvertently move positions.

By one approach, the actuation mechanisms have one or more extensions or projections configured to mate with one or more corresponding geometries of the remainder of the rotary cutter 200. For example, the first actuation mechanism 270 can have a first projection 275 located on the first shaft 272 and the second actuation mechanism 271 can have a second projection 276 located on the second shaft 273. The first actuation mechanism 270 can also include a first lower shaft 278 that is connected to the first shaft 273 via a sidewall 277 that extends between the terminal end of the first shaft 272 and the first lower shaft 278. The first actuation mechanism 270 can also include a detent mechanism 215. In some embodiments, the detent mechanism 115 is positioned between the first shaft 273 and the first lower shaft 278 to the first actuator grip 224. The detent mechanism 215 may also include a spring 286. In such a configuration, a first end of the spring can be coupled to the first shaft 272 and the second end of the spring 286 can be coupled to a button 287 provided on the first lower shaft 278. The spring 286 can be configured to provide a biasing force on the first shaft 272 in direction D26, such that when the spring 286 is in its natural state it keeps the distance M23 between the first shaft 272 and the first lower shaft 278 at such a distance that the first shaft 273 sits flush with the first shield 220 of the first actuation mechanism 270.

In some approaches, the first side 284 of the body 205 of the rotary cutter 200 may also include one or more respective recesses 288,289. For example, the recesses 288, 289 may be disposed in a flange 262 extending from a sidewall 261 of the first side 284 of the body 205. The sidewall 261 and the flange 262 provided in the first side 284 of the body 205 provide a slidable path for which the first actuation mechanism 270 can slide back and forth along the cutout portion 274 in the first side 284 in the body 205. As illustrated, the recesses 288,289 provided along the slidable track are cut out from the flange 262, such that recesses 288,289 interrupt the generally smooth bottom surface 269 provided by the flange 262. As also illustrated, the recesses 288,289 provided along the flange 262 will have a shape such that the first projection 275 can enter the recesses 288,289.

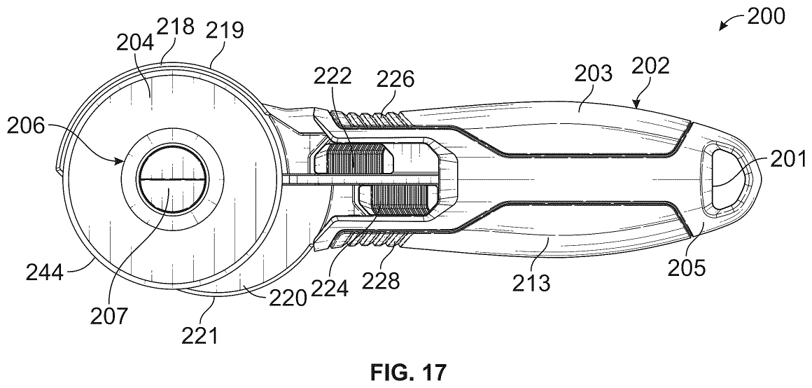

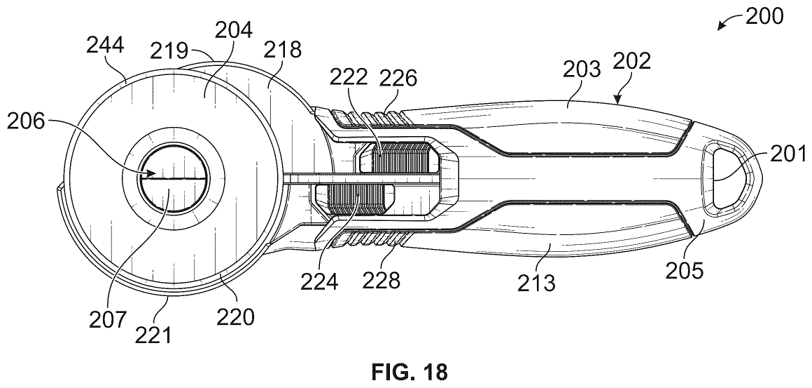

In the illustrated embodiment there are two recesses 288,289 that are positioned along the flange 262 at such positions that when the first projection 275 is received in the frontmost recess 288 the first shield 218 will be in the fully extended position (FIG. 17) and when the first projection 275 is received into the rearmost recess 289 the first shield 218 will be in the fully retracted position (FIG. 18).

Accordingly, if the user wants to move the first shield 218 from its fully extended position to its fully retracted position the user will first need to release the first projection 275 from the frontmost recess 288. To do so, sufficient force will need to be applied on the first actuator grip 222 in direction D25 to overcome the biasing force that the spring 286 is providing on the shaft 272 in direction D26. Once sufficient force has been applied in direction D25 it will cause the spring 286 to compress and cause the portion of the first shaft 272 located proximate to the first actuator grip 222 to begin flexing in direction D25 towards the first lower shaft 278. Once sufficient force has been applied in Direction D25 the portion of the first shaft 272 with the first projection 275 will eventually flex in direction D25 enough, such that the first projection 275 will fully exit or sufficiently disengage from the frontmost recess 288. The user can then apply an axial force on the first actuator grip 222 in direction D11 (FIG. 13) which will cause the now released first actuation mechanism 270 including the first shield 218 to also move in direction D11. As the first actuation mechanism 270 is moved in direction D11 the spring 286 will remain compressed either by the force being applied by the user or by coming into contact with the portion of the surface 269 of the flange 262 located between the frontmost recess 288 and the rearmost recess 289. The user will then continue applying an axial force on the first actuator grip 222 in direction D11 until the first projection 275 passes over the rearmost recess 289 in the flange 262 where the still compressed spring 286 will immediately bias the first shaft 272 in direction D26, which will cause the first projection 275 to be received into the rearmost recess 289. The spring 286 will then keep the first actuation mechanism 270 including the first shield 218 in the fully retracted state by biasing the first projection 275 against the rearmost recess 289 in the flange 262 provided in the body 205. Furthermore, as the first projection 275 is being biased in the rearmost recess 289 the first projection 275 will prevent the movement of the first actuation mechanism 270 in either direction D11 or D12 (FIG. 13) because the first projection 275 will come into contact with the sides of the rearmost recess 289 if the first actuation mechanism 270 is attempted to be moved in direction D11 or D12.

Then if the user wants to move the first shield 218 from its fully retracted position back to its fully extended position the user will need to release the first projection 275 from the rearmost recess 289. To do so, sufficient force will need to be applied on the first actuator grip 222 in direction D25 to overcome the biasing force that the spring 286 is providing on the shaft 272 in direction D26. Once sufficient force has been applied in direction D25 it will cause the spring 286 to compress and cause the portion of the first shaft 272 located proximate to the first actuator grip 222 to begin flexing in direction D25 towards the first lower shaft 278. Once sufficient force has been applied in Direction D25 the portion of the first shaft 272 with the first projection 275 will eventually flex in direction D25 enough, such that the first projection 275 will fully exit or sufficiently disengage from the rearmost recess 289. The user can then apply an axial force on the first actuator grip 222 in direction D12 (FIG. 13) which will cause the now released first actuation mechanism 270 including the first shield 218 to also move in direction D12. As the first actuation mechanism 270 is moved in direction D12 the spring 286 will remain compressed either by the force being applied by the user or by coming into contact with the portion of the surface 269 of the flange 262 located between the rearmost recess 289 and the frontmost recess 288. The user will then continue applying an axial force on the first actuator grip 222 in direction D12 until the first projection 275 passes over the frontmost recess 288 in the flange 262 where the still compressed spring 286 will immediately bias the first shaft 272 in direction D26, which will cause the first projection 275 to be received into the frontmost recess 288. The spring 286 will then keep the first actuation mechanism 270 including the first shield 218 in the fully extended state by biasing the first projection 275 against the frontmost recess 288 in the flange 262 provided in the body 205.

As will appreciated, if the user wants to move the second shield 220 from its fully extended position (FIG. 18) to its fully retracted position (FIG. 17) the user will perform similar steps as discussed above relative to the first actuation mechanism 270 but execute them on the corresponding components of the second actuation mechanism 271. This will cause a similar interaction between the second projection 276 provided on the second shaft 273 of the second actuation mechanism 271 and the frontmost and rearmost recess 289 of a flange 262 that corresponds to the one discussed above except that it is located along the second side 283 of the first side 284 of the body 205.

According to one aspect, the first actuation mechanism 270 and the second actuation mechanism 271 can be formed of a variety of materials. According to another aspect, the first actuation mechanism 270 and the second actuation mechanism may be formed from a plastic material, such as, an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some configurations, the first actuation mechanism 270 includes a first actuator grip 222 that is formed along the top surface of the first shaft 272 and the second actuation mechanism 271 includes a second actuator grip 224 that is formed along the top surface of the second shaft. The first actuator grip 222 and the second actuator grip 224, in some embodiments, have a textured surface, such as a repeating pattern of valleys 240. By some approaches, the valleys 240 have a first angular side 242 and a second angular side 244 that meet to form a lowermost portion thereof. Advantageously, the repeating pattern included along the surfaces of the first actuator grip 222 and the second actuator grip 224 provides increase traction between this surface and a user's finger or thumb.

As noted, the first actuation mechanism 270 also has a first shield 218 associated therewith and the second actuation mechanism 271 has a second shield 220 associated therewith. The first shield 218 typically extends from the first shaft 272 of the first actuation mechanism 270 and the second shield 220 typically extends from the second shaft 273 of the second actuation mechanism 273. In one embodiment, the first shield 218 and the second shield 220 both having a generally semicircular shape, such that when the first shield 218 and the second shield 220 are positioned adjacent to one another they form a generally circular shape.

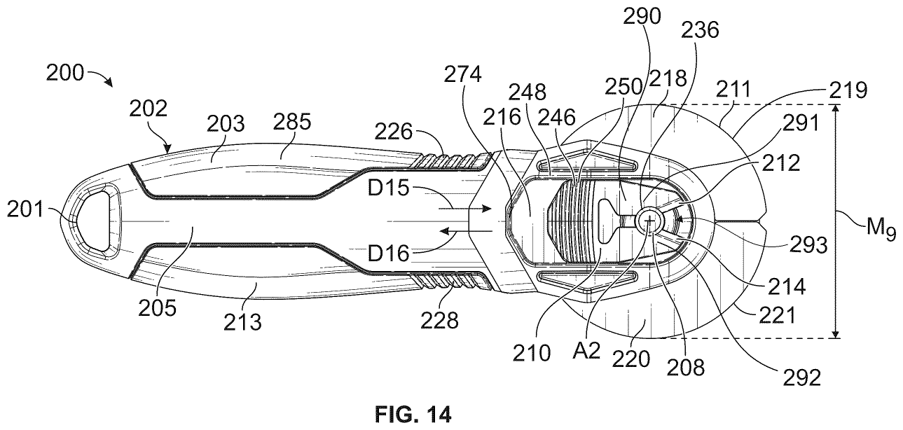

By some approaches, when the first shield 218 and the second shield 220 are positioned adjacent to one another the generally circular shape formed by the first shield 218 and the second shield 220 has a diameter M9 (see FIG. 14) which is greater than the diameter M8 of the rotary blade 204 (see FIG. 13), such that when the first shield 218 and the second shield 220 are positioned adjacent to one another and overlay the rotary blade 204, the edge 219 of the first shield 218 and the edge 221 of the second shield 220 will extend beyond the edge 244 of the rotary blade 204. Advantageously, such a configuration may prevent the edge 244 of the rotary blade 204 from coming into accidental contact with and/or accidentally causing damage to an object or a user when the rotary blade 204 is not in use. In addition to preventing unintentional injury or accidental usage of the rotary blade 204, it also helps retain the blade in good working order so that it doesn't become dull or damaged.

In addition, by having the first shield 218 and the second shield 220 independently actuated, the rotary cutter 200 may be utilized in a number of different configurations. More particularly, the rotary cutter 200 is capable of being used to cut a material, when one or both of the shields 218, 220 are in their retracted positions. Furthermore, as described above, the notch 297 permits a user to cut threads or other small items even without one or both of the shields being retracted.

By one approach, the diameter M9 of the first shield 218 and the second shield 220 is between about 0.1 mm to 2 mm greater than the diameter M8 of the rotary blade 204. In yet another approach, the difference in the diameter of M9 and M8 is between about 0.25 mm to 1 mm. Further, in some configurations, the diameter M8 of the rotary blade 204 is about 60 mm and the diameter M9 of the first shield 218 and the second shield 220 is between about 60.1 mm and 61 mm.

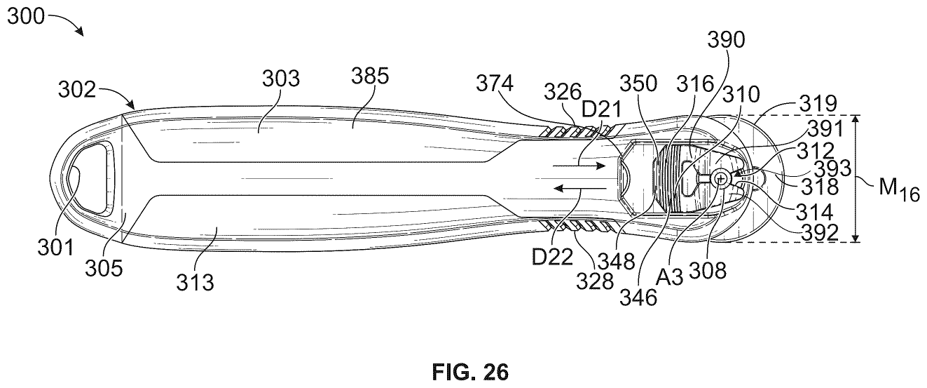

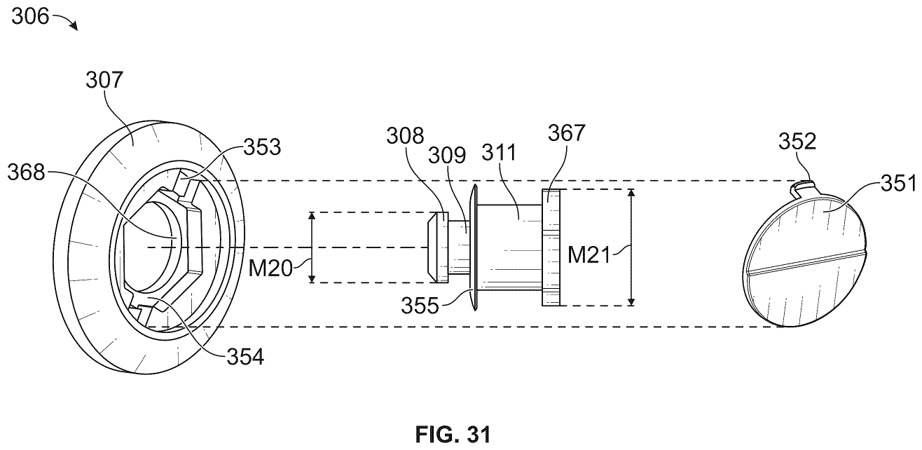

In some approaches, the first shield 218 and the second shield 220 each have respective beaded edges 219, 221 and respective cutout portions 295,296. As shown in FIG. 31, the respective cutout portions 295,296 form an opening 234 between the first shield 218 and the second shield 220 that is configured to accommodate an axle shaft or blade retention member 211 of the blade holder 206 (see, e.g., FIG. 26) as the first shield 218 and the second shield 220 are moved between their respective retracted and extended positions.

In some embodiments, the first shield 218 and the second shield 220 also may have a notch formed therein. In one illustrative embodiment, a respective first notch 298 and a respective second notch 299 are formed in the shields, such as at their respective beaded edges 219, 221. When the first shield 218 and the second shield 220 are in their fully extended state the first notch 298 and the second notch 299 align with one another and form a crevasse 297 through the first shield 218 and the second shield 220 such that the edge 244 of the rotary blade 204, which is located adjacent to the crevasse 297, can come into contact with and cut an object that is small enough to fit within the crevasse 297, such as, e.g., a piece of paper, wire, or thread. In this manner, the rotary cutter 200 may be used to snip or cut, for example, a thread from a piece of material without manually engaging one of the actuation mechanisms 270, 271 and moving one of the associated shields 218, 220.

As suggested above, in some configuration, the first shield 218 has a first or extended position in which the first shield 218 shields, seats, nests, guards, overhangs or abuts with the edge 244 of a first portion of the rotary blade 204 and a second or retracted position in which the first shield 218 does not shield, seat, or abut at least a portion of the edge 244 of the first portion of the rotary blade 204. Likewise, the second shield 220 having a first or extended position in which the second shield 220 shields, seats, nests, guards, overhangs or abuts the edge 244 of a second portion of the rotary blade 204 and a second or retracted position in which the second shield 220 does not shield, seat, or abut at least a portion of the edge 244 of the second portion of the rotary blade 204.

In operation, to move the first shield 218 from the first or extended position (see FIG. 17) to the second or retracted position (see FIG. 18) a user will need to actuate the first actuation mechanism 270 in direction D11 (see, e.g., FIG. 13). During typical use, a user will place their finger on the first actuator grip 222 and then apply an inward and generally lateral force on the first actuator grip 222 in direction D11. By some approaches, a user typically presses the actuator grip 222 inward toward a rear or second side 285 of the rotary cutter 200. When the user applies the generally lateral force on the first actuator grip 222 in direction D11 it will cause both the shaft 272 and the first shield 218 to move in direction D11 in accordance with the movement of the first actuator grip 222 due to the first shield 218 and the first shaft 272 being integrally formed from the same piece of material and the first actuator grip 222 being coupled to the shaft 272.

Likewise, when a user wants to move the first shield 218 from the second or retracted position (see FIG. 18) to the first or extended position (see FIG. 31) the user will need to actuate the first actuation mechanism 270 in direction D12. Typically, the user will place their finger on the first actuator grip 222 and then apply an inward and generally lateral force on the first actuator grip 222 in direction D12. When the user applies the generally lateral force on the first actuator grip 222 in direction D12 it will also cause the first shaft 272 and the first shield 218 to move in direction D12 in accordance with the movement of the first actuator grip 222 due to the first shield 218 and the first shaft 272 are integrally formed from the same piece of material as the first actuator grip 222.

To move the second shield 220 from the first or extended position (see FIG. 18) to the second or retracted position (see FIG. 17) a user will need to actuate the second actuation mechanism 271 in direction D14. To do so, a user will typically place their finger on the second actuator grip 224 and then apply an inward and a generally lateral force on the second actuator grip 224 in direction D14. When the user applies the generally lateral force on the second actuator grip 224 in direction D14 it will also cause the shaft 273 and the second shield 220 to move in direction D14 in accordance with the second actuator grip 224 because the second shield 220 and the second shaft 273 are integrally formed from the same piece of material and the second actuator grip 224 is coupled to the second shaft 273.

Likewise, when a user wants to move the second shield 220 from the second or retracted position (see FIG. 17) to the first or extended position (see FIG. 18) the user will need to actuate the second actuation mechanism 271 in direction D13. Under normal operation, a user will typically put their finger on the second actuator grip 224 and then apply an inward and generally lateral force on the second actuator grip 224 in direction D13. When the user applies the inward and generally lateral force on the second actuator grip 224 in direction D13 it will also cause the second shaft 273 and the second shield 220 to move in direction D13 in accordance with the second actuator grip 224 due to the second shield 220 and the second shaft 273 being integrally formed from the same piece of material and the second actuator grip 224 being coupled to the second shaft 273.

Further, as the embodiment of the rotary cutter 200 disclosed herein has a first actuation mechanism 270 including a first shield 218 that is responsible for shielding, seating or abutting the top half of the rotary blade 204 and a second actuation mechanism 271 that includes a second shield 220 that is responsible for shielding, seating or abutting the bottom half of the rotary blade 204, a user typically has the option to retract one or both of the first shield 218 and second shield 220 at any given time to expose more or less of the edge 244 of the rotary blade 204 to suit the needs of the user at that particular time.

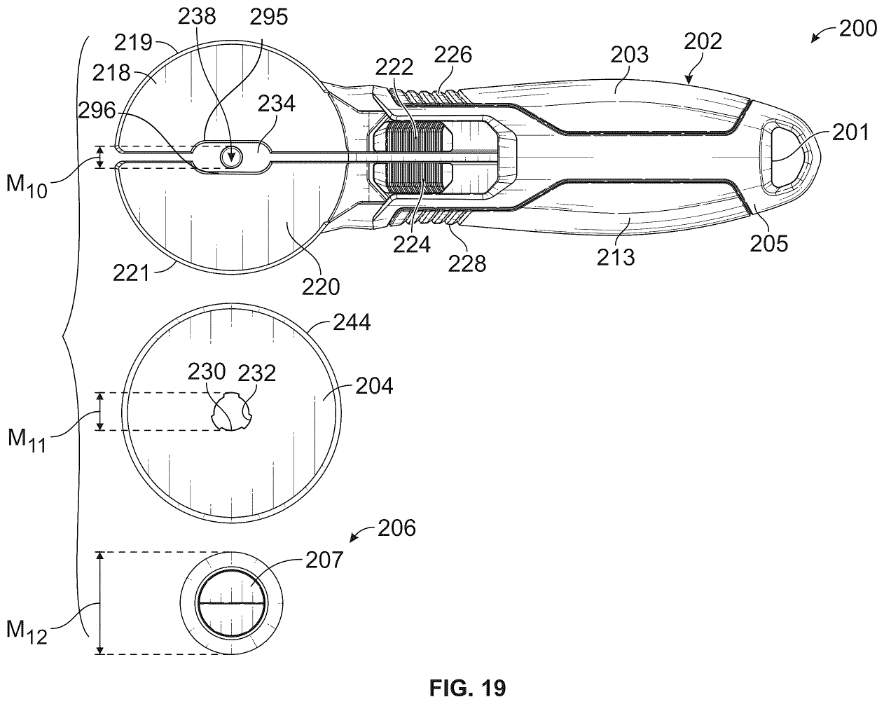

Positioned adjacent to the front end 280 of the rotary cutter 200 is a blade holder 206 (see, e.g., FIGS. 10 and 19) capable of receiving and rotationally coupling a rotary blade 204 to the handle 202. In this manner, the rotary blade 204 is capable of rotating about axis A2 in a first direction D9 and a second direction D10.

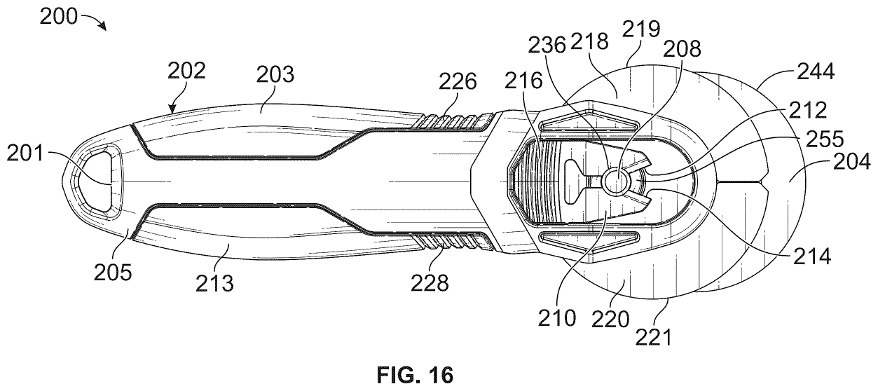

As shown in FIGS. 16 and 18, the blade holder 206, in one illustrative configuration, includes a hub cap 207 and an axle shaft 211. The axle shaft 211 includes a first expanded end member 267 and a second expanded end member 208 with a shaft 294 extending therebetween. The second expanded end member 208 of the axle shaft 211 has a diameter M13, which is smaller than an opening 232 in the rotary blade 204, which has a diameter M11. In addition, the body 205 of the rotary cutter may have an opening 238 with a diameter M10. In this manner, the second expanded end member 208 of the axle shaft 211 can pass through the opening 232 in the rotary blade 204 and the opening 238 extending through the body 205 of the rotary cutter 200. Further, the first expanded end member 267 of the axle shaft 211 has a diameter M14 that is larger than the opening 232 in the rotary blade 204 and the opening 238 extending through the body 205 of the rotary cutter, such that the first expanded end member 267 cannot pass through the opening 232 in the rotary blade 204 or the opening 238 extending through the body 205 of the rotary cutter 200. The axle shaft 211 may further include a groove 209 located proximate to the second expanded end member 208 of the axle shaft 211. The rotary cutter 100 also may include a washer 255. By some approaches, the washer 255 is configured to abut against the side of the groove 208 opposite the second expanded end member 208 and abut against the retaining clip 210 when the blade holder 206 has been installed and secured to the body 205 of the rotary cutter 200.

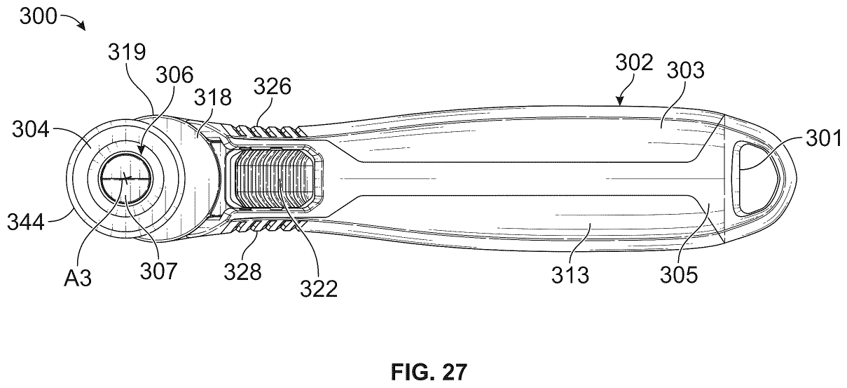

As shown in FIG. 27, in one illustrative approach, the hub cap 207 has a generally disk-like shape having a diameter M12 and includes an opening 268 and a seated portion 254 that is shaped like the first end member 267 of the axle shaft 211. Advantageously, the seated portion 254 of the hub cap 207 is configured to engage with and retain the first end member 267 when the axle shaft 211 is inserted second expanded member 208 side first through the opening 268 of the hub cap 207. The hub cap 207 also typically includes a cover 251 that is generally circular in shape and includes flanges 252 disposed on about its perimeter that are configured to engage with and be retained by notches 253 provided in the hub cap 207. In some embodiments, the manufacturer's name or other relevant information like the appropriately sized rotary blade 204 to use with the rotary cutter 200 may be placed on the hub cap cover 251.

In some embodiments, the retaining clip 210 includes a body 290 including a first prong 291 and a second prong 292 extending from the body 290. The first prong 291 may have a first angled surface 212 and the second prong 292 may have a second angled surface 214 with an opening 293 provided therebetween. In some approaches, the retaining clip 210 is slidably connected to the body 205 of the rotary cutter 200, such that a user can move the retaining clip 210 in a first direction D15 and a second direction D16 relative to the body 205 of the rotary cutter 200 by actuating the retaining clip 210 in direction D15 and D16 respectively.

As shown in FIG. 14, the retaining clip 210 may include a thumb grip 216 having a textured surface, such as a repeating pattern of ridges 246. By some approaches, the ridges 246 of the thumb grip 216 have a first angular side 248 and a second angular side 250 that meet to form a pinnacle of each of the ridges 246. Advantageously, the textured surface including the repeating pattern of ridges 246 provided on the thumb grip 216 may provide a user with additional traction when actuating the retaining clip in direction D15 and D16.

When a rotary blade 204 has been installed on the rotary cutter 200 it is held in place, in part, by an axle shaft 211 whose second end member 208 is received through the opening 232 in the rotary blade 204. Once the axle shaft 211 has been inserted through the opening 232 of the rotary blade 204 the axle shaft 211 will then be inserted through opening 238 in the body 205 of the rotary cutter 200.

In one illustrative configuration, the axle shaft 211 is secured to the body 205 of the rotary cutter 200 by a retaining clip 210 that engages with a groove 209 (FIG. 27) of the axle shaft 211 (which in some approaches is formed proximate to the second end member 208). The groove 209 of the axle shaft 211 is configured to be received between prongs of the retaining clip. More specifically, the axle shaft 211 is retained by the first angled surface 212 of the first prong 291 and the second angled surface 214 of the second prong 292 (FIG. 14). In an exemplary approach, the retaining clip 210 is advanced into its secured position retaining the rotary blade 204, by advancing the axle shaft 211 into a channel 236 formed between the first prong 291 and the second prong 292. By some approaches, a user holds the hub cap 207 in place while advancing the thumb grip 216 of the retaining clip 210 toward the forward end 280 thereby advancing the prongs 291, 292 into position around the axle shaft 211. Also, in some embodiments, the angled surfaces 212, 214 of the prongs 291, 292 engage with the groove 209 on the axle shaft 211 to guide the axle shaft 211 into the channel 236.

As suggested above, a user typically applies sufficient force on the thumb grip 216 of the retaining clip 210 in direction D15 to force the groove 209 of the axle shaft 211 into position between the terminating ends of the first angled surface 212 and the second angled surface 214 and into the channel 236. As the size of the channel 236 formed between the first prong 291 and the second prong 292 of the retaining clip 210 is large enough to receive the groove 209 of the axle shaft 211 but smaller than the diameter M13 of the second retaining member 208, the axle shaft 211 is secured to the body 205 at one end by the second retaining member 208 that rests against the retaining clip 210. In addition, at the other end of the axle shaft 211, it is retained by the first retaining member 267 (FIG. 27) that is also rotatably coupling the rotary blade 204 to the body 205 of the rotary cutter 200.

In one approach, the body 202 has a cutout 274 (FIG. 14) formed therein on a side thereof opposite the actuation mechanisms. In one embodiment, the cutout 274 is sized to permit the retaining clip 210 to be moved in a lateral direction therein, thereby permitting the retaining clip 210 to engage and disengage a secure connection between the blade holder 206 and the prongs 291, 292. In addition, the cutout 274 is sized to prevent the retaining clip from being easily separated from the body 202. Accordingly, it is sized to be just slightly larger than the retaining clip 210. Indeed, while a user may easily remove the blade 204 once the retaining clip 210 is moved to a release position, the retaining clip 210 itself is not easily released or separated from the body 202 as it is retained in the cutout 274, which is sized to permit lateral movement of the retaining clip 210 but not to permit easy, manual removal of the retaining clip 210 from the body 202. In yet another embodiment, the cutout 274 may have an upper ledge or flange at an upper end thereof to further prohibit the retaining clip 210 from being removed from the body 202.

Advantageously, the rotary cutter 200 described herein allows a user to replace the rotary blade 204 with a new rotary blade 204 when desired. This allows the user to replace a rotary blade 204 whose edge 244 has become dull, damage, or dirty and/or to swap out the current rotary blade 204 for a different style of rotary blade 204 that is more suitable for cutting a particular material or for providing the user with a particular effect when cutting a material. Further, by having a replaceable blade in the rotary cutter 200, the handle 202 may be reused with other blades after the initial rotary blade 204 has become worn out.

To remove the rotary blade 204 currently coupled with the rotary cutter 200, a user will typically place the first shield 218 and the second shield 220 in their extended positions to ensure that the edge 244 of the rotary blade 204 that is currently coupled to the rotary cutter 200 is covered during the removal process. The user then typically actuates the thumb grip 216 of the retaining clip 210 in direction D16 with sufficient force to cause the axle shaft 211 to become dislodged from the retaining clip. More particularly, the groove 209 of the axle shaft 211 becomes disengaged from the channel 236 and between the first angular surface 212 and the second angular surface 214 of the respective first prong 291 and second prong 292 of the retaining clip 210.

In this manner, the user can then continue to actuate the thumb grip 216 of the retaining clip 210 in direction D16 until no portion of the retaining clip 210 remains between the second end member 208 of the axle shaft 211 and the body 205 of the rotary cutter 200. The user may then simply slide the axle shaft 211 out through the opening 238 in the body 205 of the rotary cutter 200 and then remove the utility blade 204 that is being replaced by passing the utility blade 204 over the axle shaft 211 in the direction of the second end member 208 until the opening 232 of the utility blade 204 passes over the second end member 208 and the utility blade 204 is clear of the axle shaft 211.

Then to install a new rotary blade 204 onto the rotary cutter 200, a user will first ensure that the retaining clip 210 is in an unlocked state by actuating the thumb grip 216 in direction D16 until retaining clip 210 is not blocking the opening 238 in the body 205 of the rotary cutter 200. The user can then insert the first expanded end member 208 of the axle shaft 211 through the opening 232 in the rotary blade 204. Once the first expanded end member 208 of the axle shaft 211 has been inserted through the opening 232 in the rotary blade the user will then insert the first expanded end member 208 of the axle shaft 211 through the opening 238 in the body 205 of the rotary cutter 200 until the groove 209 on the axle shaft 211 is at least partially extending through the opening 238 in the body 205 of the rotary cutter 200. The user will then place the retaining clip 210 into a locked state by engaging the thumb grip 216 to advance the retaining clip 210 in direction D15 toward the axle shaft 211.

As the user advances the retaining clip 210 in direction D15, the groove 209 on the axle shaft 211 is typically received by in the tapered opening 293 formed between the first prong 291 and the second prong 292 of the retaining clip 210. In one approach, the tapered opening 293 is defined, in part, (by the first angular surface 212 of the first prong 291 and the second angular surface 214 of the second prong 292.

After the groove 209 of the axle shaft 211 has passed into the channel 236 of the retaining clip 210, the force that was being applied by the user on the first angular surface 212 and the second angular surface 214 is removed or reduced due to the passing of the axle shaft 211 into the channel 236. Once the force has been removed from the first angular surface 212 and the second angular surface 214 it typically causes the first prong 291 and the second prong 292 to return to their natural state by shifting slightly closer together, such that the distance between the first angular surface 212 and the second angular surface 214 adjacent to the channel 236 are typically less than the diameter of the groove 209 in the axle shaft 211. Accordingly, this will prevent the axle shaft 211 from inadvertently passing out of the channel 236 and into the opening 293 defined by the first angular surface 212 and the second angular surface 214 without a user applying sufficient force on the first angular surface 212 and the second angular surface 214 via the thumb grip 216.

Advantageously, the rotary cutter 200 can be used with a variety of rotary blades, such as the rotary blade 204 illustrated in FIG. 13. By some approaches, the rotary blade may include a generally straight or flat blade, a pinking rotary blade, a chenille rotary blade, a slash cutter rotary blade, a skip-cut rotary blade, scallop rotary blade, and/or a wave rotary blade, among others. In addition, the rotary blade 204 may be formed of a variety of material, such as, e.g., steel, stainless steel, and/or titanium bonded steel, among others. Likewise, the rotary cutter 200 and the rotary blade 204 can be configured in a variety of sizes and/or shapes. Further, the rotary cutter 200 is configured to receive rotary blades 204 having notches 230 about their central opening 232 along with rotary blades 204 having a more generally circular central opening 232.

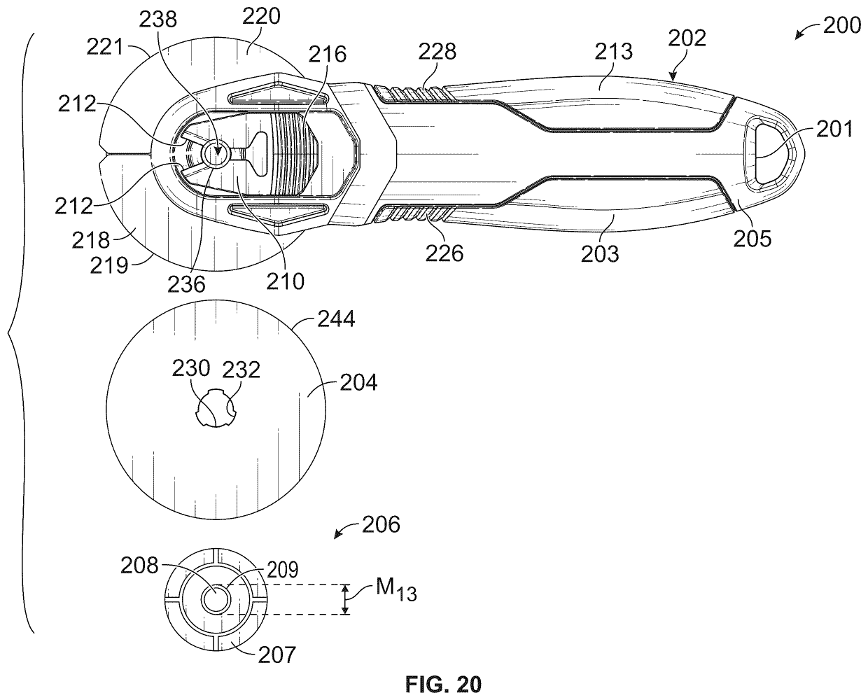

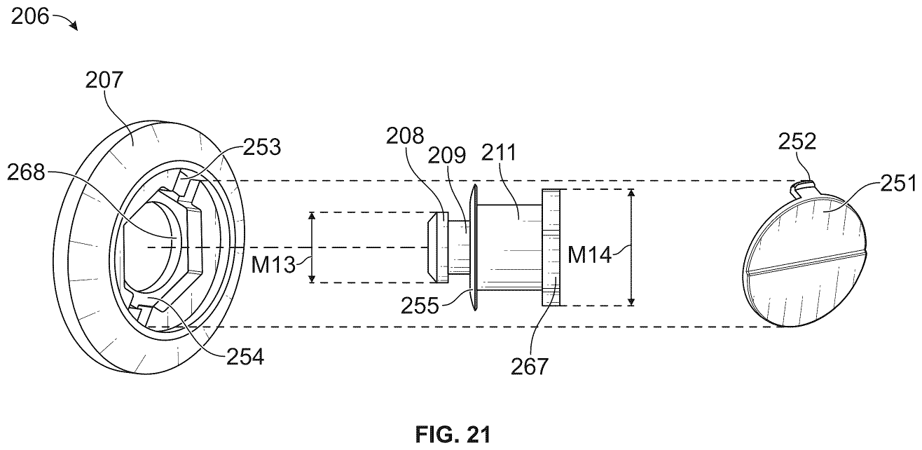

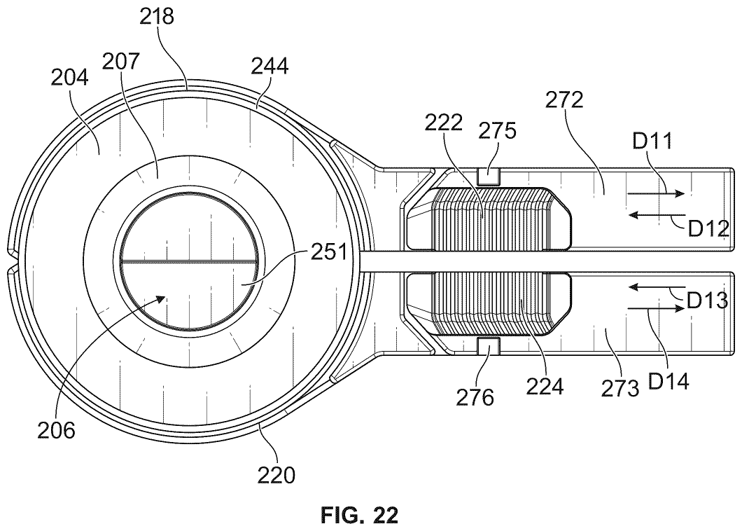

Referring now to FIG. 31, an illustrative rotary cutter 300 that is compatible with many of these teachings discussed herein is presented. More particularly, FIGS. 19-25 illustrate one embodiment of a rotary cutter 300 having a forward end 380, a rear end 381, a top surface 382, a bottom surface 383, a first side 384 and a second side 385. The rotary cutter 300, in some embodiments, is generally comprised of a handle 302, an actuation mechanism 370, a second actuation mechanism 371, a blade holder 306, a retaining clip 310, and a rotary blade 304.

As shown, the handle 302 of the rotary cutter 300 has body 305 that has a generally oblong shape. The body 305 of the handle 302 can be made from a variety of materials that are strong and durable. By some approaches, the body 305 of the handle 302 is comprised of a plastic material, such as, e.g., an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some embodiments, the handle 302 also has a first grip 303 that extends at least partially along the first side 384 of the handle, the top surface 382 of the handle 302, and the second side 385 of the handle 302. The handle 302 also may include a second grip 313 that extends at least partially along the first side 384 of the handle 302, the bottom surface 383 of the handle 302, and the second side 385 of the handle 302.

The first grip 303 and the second grip 313 can be formed of a variety of materials, including those that provide an additional grip or traction to a user's hand when the user is grasping the handle 302. In some embodiments, the first grip 303 and the second grip 313 are formed of a rubber material. More particularly, the first grip 303 and the second grip 313 may be formed of, for example, a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), and/or a Hydrogenated Nitrile (HNBR), among others. In another approach, the first grip 303 and the second grip 313 are formed of a plastic material such, e.g., a Thermoplastic Elastomer (TPE) and/or a Thermoplastic Rubber (TPR), among others.

In some configurations, the first grip 303 includes a first set or plurality of grip fins 326 located along the top surface 382 of the handle 302 and the second grip 313 has a second set or plurality of grip fins 328 located along the bottom surface 383 of the handle 302. In some configurations, the grip fins 326, 328 are disposed upon only a portion of the surface area of the grips. As shown in FIG. 31, the grip fins 326, 328 are disposed where a thumb or finger is often manipulating during usage and the grips 302, 313 have a smooth surface where a palm of the hand is more often exposed. To further provide an ergonomic configuration, the handle 302 may have a slightly pinched or narrowed section in the middle of the rotary cutter 300 and may have a wider section at an end of the handle 302 that is more often adjacent a palm of a user's hand when in use.

In some embodiments, the set of first grip fins 326 and the set of second grip fins 328 provide additional traction for the user when the user is grasping the handle 302 of the rotary cutter 300. In addition, the material of the grips themselves may provide increased grip for users.

The handle 302 also may include an aperture 301 that extends through the body 305 of the rotary cutter 300 and is located proximate to the rear end 381 of the rotary cutter 300. In use, the aperture 301 may be employed to store the rotary cutter safely and securely on any number of objects, such as, e.g., a hook or peg. The aperture 301 may also be used to insert any type of suitable fastener, such as, e.g., a carabiner, which permits the user to store the rotary cutter 300 on a number of objects. In this manner, the rotary cutter 300 may be easily and quickly removably coupled to, e.g., a strap or a loop.

In some approaches, the rotary cutter 300 further includes an actuation mechanism 370. The actuation mechanism 370 typically includes a shaft or attachment portion 372, an actuator grip 322, and a shield 318.

In some embodiments, the shaft 372 and the shield 318 of the actuator mechanism 370 are formed from a single piece of material, such that the shaft 372 and the shield 318 are integrally connected to one another, while the actuator grip 322 is discrete from, but coupled to the shaft 372, such that movement of the actuator grip 322 in either direction D19 or D20 induces a corresponding movement in direction D19 or D20 of the respective shaft 372 and the respective shield 318.

In other embodiments, one or more of the shafts, the actuator grip, or the shield of the actuation mechanism will be discrete elements that are not formed from a single piece of material. In this manner, such discrete elements are coupled to each other to form the actuation mechanism described herein.

In another embodiment, each one of the shafts, the actuator grip, and the shield are integrally connected to one another, such that they are not discrete elements, such as by being formed from a single piece of material, being adhered together, or being welded together to form the actuation mechanism described herein.

Similar to the embodiments discussed above, the rotary cutter may incorporate a manner of intermittently locking or providing stable resting positions for the various moving components, like the actuation mechanisms. In some embodiments, a manner of intermittently locking or providing a stable resting position for the actuation mechanism 370 is provided using a detent mechanism 315. In such an approach, the actuation mechanisms 370 may be configured such that when the actuation mechanism 370 is slidably actuated relative to the body 305 it has a stable resting or locking position that keeps the actuation mechanism 370 in position until further manual manipulation thereof. Accordingly, a user may utilize the rotary cutter 300 without concern that the actuation mechanism 370 may inadvertently move positions.

By one approach, the actuation mechanisms have one or more extensions or projections configured to mate with one or more corresponding geometries of the remainder of the rotary cutter 300. For example, the actuation mechanism 370 can have a first projection 375 and a second projection 376 located on the shaft 372 of the actuation mechanism 370. The actuation mechanism 370 can also include a lower shaft 378 that is connected to the shaft 372 via a sidewall 377 that extends between the terminal end of the shaft 372 and the lower shaft 378. The actuation mechanism 370 can also include a detent mechanism 315. In some embodiments, the detent mechanism 315 can be positioned between the shaft 372 and the lower shaft 378. The detent mechanism 315 may also include a spring 386. A first end of the spring can be coupled to the shaft 372. In such a configuration, the second end of the spring 386 can be coupled to a button 387 provided on the lower shaft 378. The spring 386 can be configured to provide a biasing force on the shaft 372 in direction D28, such that when the spring 386 is in its natural state it keeps the distance M25 between the shaft 372 and the lower shaft 378 at such a distance that the first shaft 372 sits flush with the first shield 320 of the actuation mechanism 370.

In some approaches, the first side 384 of the body 305 of the rotary cutter 300 may also include one or more respective recesses 388,389. For example, the recesses 388, 389 may be disposed in a flange 362 extending from a sidewall 361 of the first side 384 of the body 305. The sidewall 361 and the flange 362 provided in the first side 384 of the body 305 provide a slidable path for which the actuation mechanism 370 can slide back and forth along the cutout portion 374 in the first side 384 in the body 305. As illustrated, the recesses 388,389 provided along the slidable track are cut out from the flange 362, such that recesses 388,389 interrupt the generally smooth bottom surface 369 provided by the flange 362. As also illustrated, the recesses 388,389 provided along the flange 362 will have a shape such that the first projection 375 can enter the recesses 388,389.

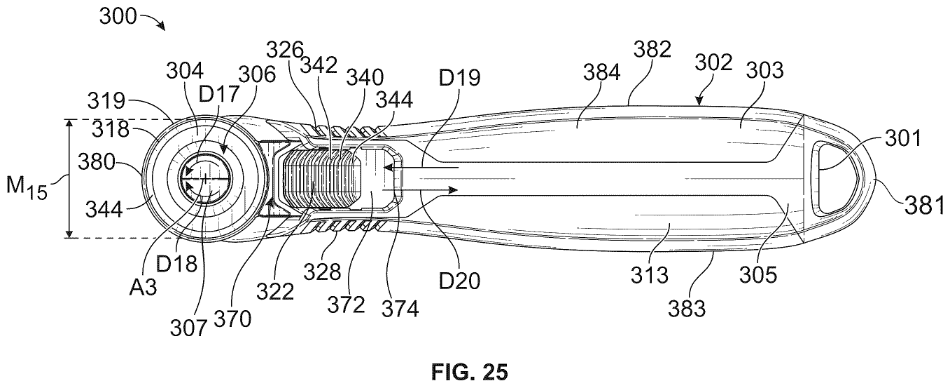

In the illustrated embodiment there are two recesses 388,389 that are positioned along the flange 362 at such positions that when the first projection 375 is received in the frontmost recess 388 the shield 318 will be in the fully extended position (FIG. 25) and when the first projection 375 is received into the rearmost recess 389 the shield 318 will be in the fully retracted position (FIG. 27).

Accordingly, if the user wants to move the shield 318 from its fully extended position to its fully retracted position the user will first need to release the first projection 375 from the frontmost recess 388. To do so, sufficient force will need to be applied on the actuator grip 322 in direction D27 to overcome the biasing force that the spring 386 is providing on the shaft 372 in direction D28. Once sufficient force has been applied in direction D27 it will cause the spring 386 to compress and cause the portion of the shaft 372 located proximate to the actuator grip 322 to begin flexing in direction D27 towards the lower shaft 378. Once sufficient force has been applied in Direction D27 the portion of the shaft 372 with the first projection 375 will eventually flex in direction D27 enough, such that the first projection 375 will fully exit or sufficiently disengage from the frontmost recess 388. The user can then apply an axial force on the actuator grip 322 in direction D20 (FIG. 25) which will cause the now released actuation mechanism 370 including the shield 318 to also move in direction D20. As the actuation mechanism 370 is moved in direction D20 the spring 386 will remain compressed either by the force being applied by the user or by coming into contact with the portion of the surface 369 of the flange 362 located between the frontmost recess 388 and the rearmost recess 389. The user will then continue applying an axial force on the actuator grip 322 in direction D20 until the first projection 375 passes over the rearmost recess 389 in the flange 362 where the still compressed spring 386 will immediately bias the shaft 372 in direction D28, which will cause the first projection 375 to be received into the rearmost recess 389. The spring 386 will then keep the actuation mechanism 370 including the shield 318 in the fully retracted state by biasing the first projection 375 against the rearmost recess 389 in the flange 362 provided in the body 305. Furthermore, as the first projection 375 is being biased in the rearmost recess 389 the first projection 375 will prevent the movement of the actuation mechanism 370 in either direction D19 or D20 (FIG. 25) because the first projection 375 will come into contact with the sides of the rearmost recess 389 if the actuation mechanism 370 is attempted to be moved in direction D19 or D20.

Then if the user wants to move the shield 318 from its fully retracted position back to its fully extended position the user will need to release the first projection 375 from the rearmost recess 389. To do so, sufficient force will need to be applied on the actuator grip 322 in direction D27 to overcome the biasing force that the spring 386 is providing on the shaft 372 in direction D28. Once sufficient force has been applied in direction D27 it will cause the spring 386 to compress and cause the portion of the shaft 372 located proximate to the actuator grip 322 to begin flexing in direction D27 towards the lower shaft 378. Once sufficient force has been applied in Direction D27 the portion of the shaft 372 with the first projection 375 will eventually flex in direction D27 enough, such that the first projection 375 will fully exit or sufficiently disengage from the rearmost recess 389. The user can then apply an axial force on the actuator grip 322 in direction D19 (FIG. 25) which will cause the now released actuation mechanism 370 including the shield 318 to also move in direction D19. As the actuation mechanism 370 is moved in direction D19 the spring 386 will remain compressed either by the force being applied by the user or by coming into contact with the portion of the surface 369 of the flange 362 located between the rearmost recess 389 and the frontmost recess 388. The user will then continue applying an axial force on the actuator grip 322 in direction D19 until the first projection 375 passes over the frontmost recess 388 in the flange 362 where the still compressed spring 386 will immediately bias the shaft 372 in direction D28, which will cause the first projection 375 to be received into the frontmost recess 388. The spring 386 will then keep the actuation mechanism 370 including the shield 318 in the fully extended state by biasing the first projection 375 against the frontmost recess 388 in the flange 362 provided in the body 305.

According to one aspect, the actuation mechanism 370 can be formed of a variety of materials. For example, the actuation mechanism 370 may be formed from a plastic material, such as, an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), and/or a Polystyrene (PS or Styrofoam), among others.

In some configurations, the actuation mechanism 370 includes an actuator grip 322 that is formed along the top surface of the shaft 372. In some embodiments, the actuator grip 322 may have a textured surface, such as a repeating pattern of valleys 340. By some approaches, the valleys 340 have a first angular side 342 and a second angular side 344 that meet to form a lowermost portion thereof. Advantageously, the repeating pattern included along the surfaces of the actuator grip 322 provides increase traction between this surface and a user's finger or thumb.

As noted, the actuation mechanism 370 also has a shield 318 associated therewith. The shield 318 typically extends from the shaft 372 of the actuation mechanism 370. In some configurations the shield 318 will be of a generally circular or semicircular shape. By some approaches, the generally circular shape formed by the shield 318 has a diameter M16 (see FIG. 26) which is greater than the diameter M15 of the rotary blade 304 (see FIG. 31), such that when the shield 318 is positioned adjacent to and overlays with the rotary blade 304, the edge 319 of the shield 318 extends beyond the edge 344 of the rotary blade 304. Advantageously, such a configuration may prevent the edge 344 of the rotary blade 304 from coming into accidental contact with and/or accidentally causing damage to an object or a user when the rotary blade 304 is not in use. In addition to preventing unintentional injury or accidental usage of the rotary blade 304, it also helps retain the blade in good working order so that it doesn't become dull, or damaged.

By one approach, the diameter M16 of the shield 318 is about 0.1 mm to 2 mm greater than the diameter M15 of the rotary blade 304. In yet another approach, the difference in the diameter of M16 and M15 is between about 0.25 mm to 1 mm. Further, in some configurations, the diameter M15 of the rotary blade 304 is about 18 mm and the diameter M16 of the shield 318 is between about 18.1 mm and 19 mm.

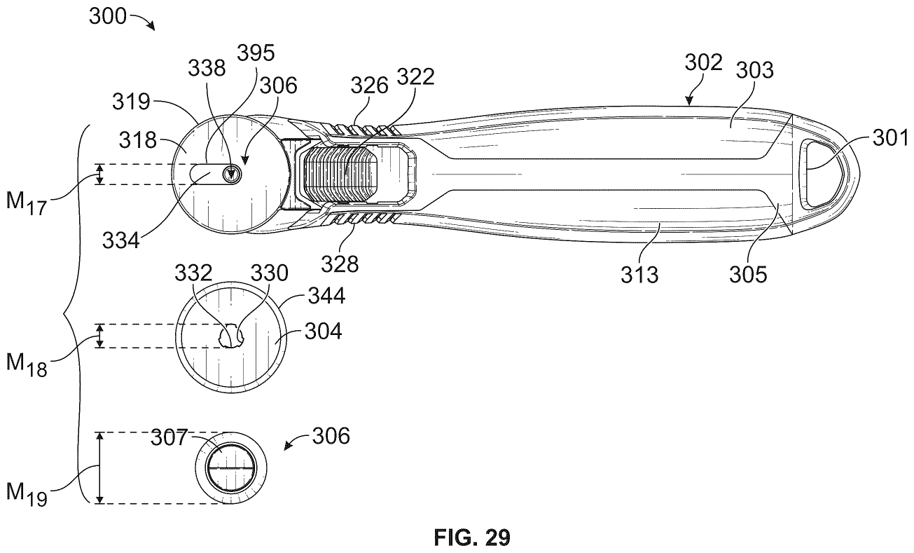

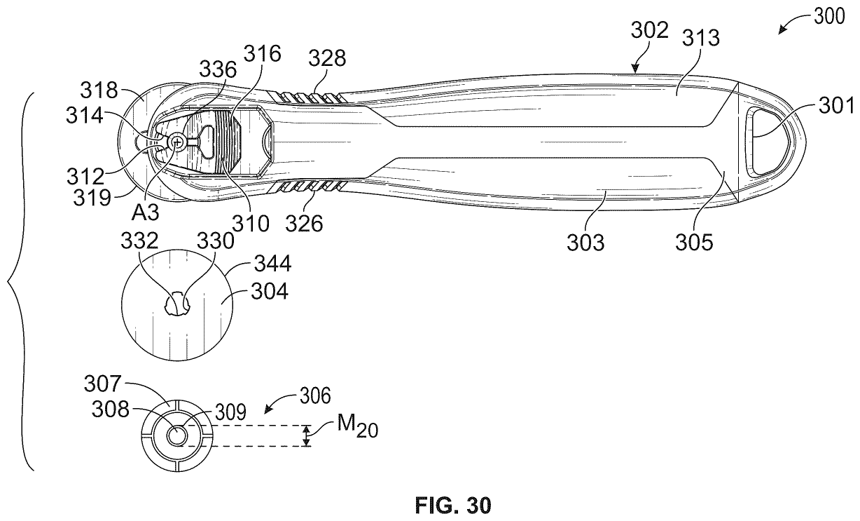

In some approaches, the shield 318 has a beaded edge 319 and a cutout portion 395. As shown in FIG. 29, the cutout portion 395 forms an opening 334 in the shield 318 to accommodate an axle shaft or blade retention member 311 of the blade holder 306 (see, e.g., FIG. 30) as the shield 318 is moved between its respective retracted and extended positions.

As suggested above, in some configurations, the shield 318 has a first or extended position in which the shield 318 shields, seats, nests, guards, overhangs or abuts with the edge 344 of the rotary blade 304 and a second or retracted position in which the shield 318 does not shield, seat, or abut at least a portion of the edge 344 of the rotary blade 304.

In operation, to move the shield 318 from the first or extended position (see FIG. 31) to the second or retracted position (see FIG. 27) a user will need to actuate the actuation mechanism 370 in direction D20 (see, e.g., FIG. 31). During typical use, a user will place their finger on the actuator grip 322 and then initially apply an inward and generally lateral force on the actuator grip 322 in direction D20. More particularly, a user typically presses the actuator grip 322 inward toward a rear or second side 385 of the rotary cutter 300. Then, when the user applies the generally lateral force on the actuator grip 322 in direction D20 it will cause both the shaft 372 and the shield 318 to move in direction D20 in accordance with the movement of the actuator grip 322 due to the shield 318 and the shaft 372 being integrally formed from the same piece of material and the actuator grip 322 being coupled to the shaft 372.

Likewise, when a user wants to move the shield 318 from the second or retracted position (see FIG. 27) to the first or extended position (see FIG. 31) the user will need to actuate the actuation mechanism 370 in direction D19. Typically, the user will place their finger on the actuator grip 322 and then apply an inward and generally lateral force on the actuator grip 322 in direction D19. When the user applies the generally lateral force on the actuator grip 322 in direction D19 it will also cause the shaft 372 and the shield 318 to move in direction D19 in accordance with the movement of the actuator grip 322 due to the shield 318 and the shaft 372 are integrally formed from the same piece of material as the actuator grip 322.

Positioned adjacent to the front end 380 of the rotary cutter 300 is a blade holder 306 (see, e.g., FIGS. 19 and 25) capable of receiving and rotationally coupling a rotary blade 304 to the handle 302. In this manner, the rotary blade 304 is capable of rotating about axis A3 in a first direction D17 and a second direction D18.

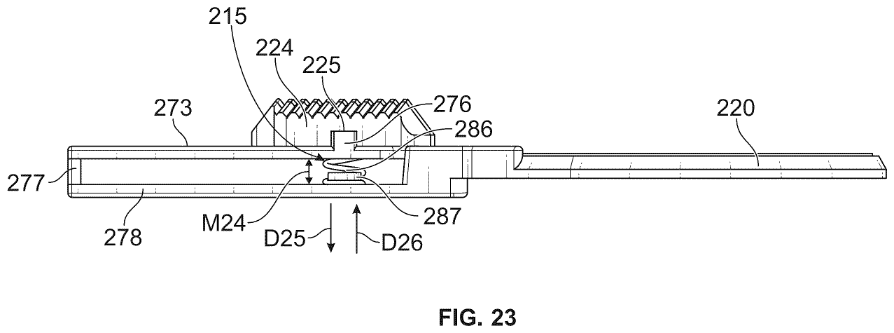

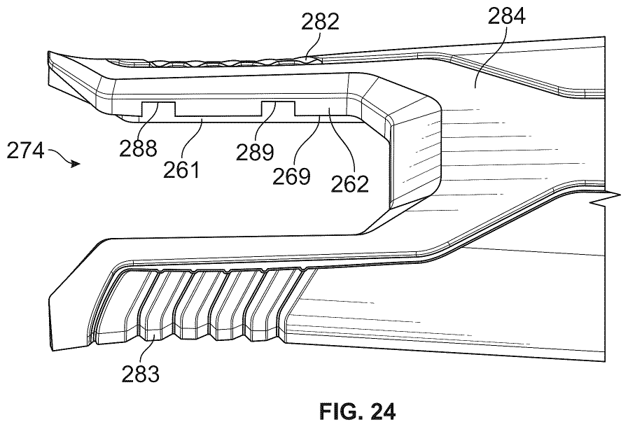

As shown in FIGS. 23 and 24, the blade holder 306, in one illustrative configuration, includes a hub cap 307 and an axle shaft 311. The axle shaft 311 includes a first expanded end member 367 and a second expanded end member 308 with a shaft 394 extending therebetween. The second expanded end member 308 of the axle shaft 311 has a diameter M20, which is smaller than an opening 332 in the rotary blade 304, which has a diameter M18. In addition, the body 305 of the rotary cutter may have an opening 338 with a diameter M17. In this manner, the second expanded end member 308 of the axle shaft 311 can pass through the opening 332 in the rotary blade 304 and the opening 338 extending through the body 305 of the rotary cutter 300. Further, the first expanded end member 367 of the axle shaft 311 has a diameter M21 that is larger than the opening 332 in the rotary blade 304 and the opening 338 extending through the body 305 of the rotary cutter, such that the first expanded end member 367 cannot pass through the opening 332 in the rotary blade 304 or the opening 338 extending through the body 305 of the rotary cutter 300. The axle shaft 311 further including a groove 309 located proximate to the second expanded end member 308 of the axle shaft 311. Also provided separate from the axle shaft 311 is washer 355. The washer 355 is configured abut against the side of the groove 308 opposite the second expanded end member 308 and is configured to abut against the retaining clip 310 when the blade holder 306 has been installed and secured to the body 305 of the rotary cutter 300.

As shown in FIG. 31, in one illustrative approach, the hub cap 307 has a generally disk-like shape having a diameter M19 and includes an opening 368 and a seated portion 354 that is shaped like the first end member 367 of the axle shaft 311. Advantageously, the seated portion 354 of the hub cap 307 is configured to engage with and retain the first end member 367 when the axle shaft 311 is inserted second expanded member 308 side first through the opening 368 of the hub cap 307. The hub cap 307 also includes a cover 351 that is generally circular in shape and includes flanges 352 disposed on about its perimeter that are configured to engage with and be retained by notches 353 provided in the hub cap 307. In some embodiments, the manufacturer's name or other relevant information like the appropriately sized rotary blade 304 to use with the rotary cutter 300 may be placed on the hub cap cover 351.

With reference to FIGS. 26 and 24, the retaining clip 310 has a body 390 including a first prong 391 and a second prong 392 extending from the body 390. The first prong 391 has a first angled surface 312 and the second prong 392 has a second angled surface 314 with an opening 393 provided therebetween. The retaining clip 310 is slidably connected to the body 305 of the rotary cutter 300, such that a user can move the retaining clip 310 in a first direction D21 and a second direction D22 relative to the body 305 of the rotary cutter 300 by actuating the retaining clip 310 in direction D21 and D22 respectively.

As shown in FIG. 26, the retaining clip 310 further including a thumb grip 316 having a textured surface including a repeating pattern of ridges 346. By some approaches, the ridges 346 of the thumb grip 316 having a first angular side 348 and a second angular side 350 that meet to form a pinnacle of each of the ridges 346. Advantageously, the textured surface including the repeating pattern of ridges 346 provided on the thumb grip 316 may provide a user with additional traction when actuating the retaining clip in direction D21 and D22.

When a rotary blade 304 has been installed on the rotary cutter 300 it is held in place, in part, by an axle shaft 311 whose second end member 308 is received through the opening 332 in the rotary blade 304. Once the axle shaft 311 has been inserted through the opening 332 of the rotary blade 304 the axle shaft 311 will then be inserted through opening 338 in the body 305 of the rotary cutter 300. The axle shaft 311 will be inserted through the opening 338 of the body 305 until the groove 309 on the axle shaft 311 is at least partially protruding through the opening 338 in the body 305 of the rotary cutter 300.

In one illustrative configuration, the axle shaft 311 is secured to the body 305 of the rotary cutter 300 by a retaining clip 310 that engages with a groove 309 (FIG. 31) of the axle shaft 311 (which in some approaches is formed proximate to the second end member 308). The groove 309 of the axle shaft 311 is configured to be received between the first angled surface 312 of the first prong 391 and the second angled surface 314 of the second prong 392 (FIG. 26). In an exemplary approach, the retaining clip 310 is advanced into its secured position retaining the rotary blade 304, by advancing the axle shaft 311 into a channel 336 formed between the first prong 391 and the second prong 392. By some approaches, a user holds the hub cap 307 in place while advancing the thumb grip 316 of the retaining clip 310 toward the forward end 380 thereby advancing the prongs 391, 392 into position around the axle shaft 311. Also, in some embodiments, the angled surfaces 312, 314 of the prongs 391, 392 engage with the groove 309 on the axle shaft 311 to guide the axle shaft 311 into the channel 336.

As suggested above, a user applies sufficient force on the thumb grip 316 of the retaining clip 310 in direction D21 to force the groove 309 of the axle shaft 311 into position between the terminating ends of the first angled surface 312 and the second angled surface 314 and into the channel 336. As the size of the channel 336 formed between the first prong 391 and the second prong 392 of the retaining clip 310 is large enough to receive the groove 309 of the axle shaft 311 but smaller than the diameter M20 of the second retaining member 308, the axle shaft 311 is secured to the body 305 at one end by the second retaining member 308 that rests against the retaining clip 310. In addition, at the other end of the axle shaft 311, it is retained by the first retaining member 367 (FIG. 31) that rotatably couples the rotary blade 304 to the body 305 of the rotary cutter 300.

In one approach, the body 302 has a cutout 374 (FIG. 26) formed therein on a side thereof opposite the actuation mechanism 370. In one embodiment, the cutout 374 is sized to permit the retaining clip 310 to be moved in a lateral direction therein, thereby permitting the retaining clip 310 to engage and disengage a secure connection between the blade holder 306 and the prongs 391, 392. In addition, the cutout 374 is sized to prevent the retaining clip from being easily separated from the body 302. Accordingly, it is sized to be just slightly larger than the retaining clip 310. Indeed, while a user may easily remove the blade 304 once the retaining clip 310 is moved to a release position, the retaining clip 310 itself is not released or disassociated from the body 302 as it is retained in the cutout 374, which is sized to permit lateral movement of the retaining clip 310 but not to permit easy, manual removal of the retaining clip 310 from the body 302. In yet another embodiment, the cutout 374 may have an upper ledge or flange at an upper end thereof to further prohibit the retaining clip 310 from being removed from the body 302.

Advantageously, the rotary cutter 300 described herein allows a user to replace the rotary blade 304 with a new rotary blade 304 when desired. This allows the user to replace a rotary blade 304 whose edge 344 has become dull, damage, or dirty and/or to swap out the current rotary blade 304 for a different style of rotary blade 304 that is more suitable for cutting a particular material or for providing the user with a particular effect when cutting a material. Further, by having a replaceable blade in the rotary cutter 300, the handle 302 may be reused with other blades after the initial rotary blade 304 has become worn out.

To remove the rotary blade 304 currently coupled with the rotary cutter 300, a user will typically place the shield 318 in its extended positions to ensure that the edge 344 of the rotary blade 304 that is currently coupled to the rotary cutter 300 is covered during the removal process. The user then typically actuates the thumb grip 316 of the retaining clip 310 in direction D22 with sufficient force to cause the axle shaft 311 to become dislodged from the retaining clip 310. More particularly, the groove 309 of the axle shaft 311 becomes disengaged from the channel 336 formed between the first prong 391 and the second prong 392 of the retaining clip 310.

In this manner, the user can then continue to actuate the thumb grip 316 of the retaining clip 310 in direction D22 until no portion of the retaining clip 310 remains between the second end member 308 of the axle shaft 311 and the body 305 of the rotary cutter 300. The user may then simply slide the axle shaft 311 out through the opening 338 in the body 305 of the rotary cutter 300 and then remove the utility blade 304 that is being replaced by passing the utility blade 304 over the axle shaft 311 in the direction of the second end member 308 until the opening 332 of the utility blade 304 passes over the second end member 308 and the utility blade 304 is clear of the axle shaft 311.

Then to install a new rotary blade 304 onto the rotary cutter 300, a user will first ensure that the retaining clip 310 is in an unlocked state by actuating the thumb grip 316 in direction D22 until the retaining clip 310 is not blocking the opening 338 in the body 305 of the rotary cutter 300. The user can then insert the first expanded end member 308 of the axle shaft 311 through the opening 332 in the rotary blade 304. Once the first expanded end member 308 of the axle shaft 311 has been inserted through the opening 332 in the rotary blade 304 the user will then insert the first expanded end member 308 of the axle shaft 311 through the opening 338 in the body 305 of the rotary cutter 300 until the groove 309 on the axle shaft 311 is at least partially extending through the opening 338 in the body 305 of the rotary cutter 300. The user will then place the retaining clip 310 into a locked state by engaging the thumb grip 316 to advance the retaining clip 310 in direction D21 toward the axle shaft 311.

As the user advances the retaining clip 310 in direction D21, the groove 309 on the axle shaft 311 is typically received by in the tapered opening 393 formed between the first prong 391 and the second prong 392 of the retaining clip 310. In one approach, the tapered opening 393 is defined, in part, (by the first angular surface 312 of the first prong 391 and the second angular surface 314 of the second prong 392.

After the groove 309 of the axle shaft 311 has passed into the channel 336 of the retaining clip 310, the force that was being applied by the user on the first angular surface 312 and the second angular surface 314 is removed or reduced due to the passing of the axle shaft 311 into the channel 336. Once the force has been removed from the first angular surface 312 and the second angular surface 314 it typically causes the first prong 391 and the second prong 392 to return to their natural state by shifting slightly closer together, such that the distance between the first angular surface 312 and the second angular surface 314 adjacent to the channel 336 are typically less than the diameter of the groove 309 in the axle shaft 311.

Accordingly, this will prevent the axle shaft 311 from passing out of the channel 336 and into the opening 393 defined by the first angular surface 312 and the second angular surface 314 without a user applying sufficient force on the first angular surface 312 and the second angular surface 314 to separate the first angular surface 312 and the second angular surface 314 far enough apart to allow a portion of the axle shaft 311, such as the groove 309, to pass from the channel 336 and into the opening 393 defined by the first angular surface 312 and the second angular surface 314 of the retaining clip 310.

Advantageously, the rotary cutter 300 can be used with a variety of rotary blades, such as the rotary blade 304 illustrated in FIG. 29. By some approaches, the rotary blade may include a generally straight or flat blade, a pinking rotary blade, a chenille rotary blade, a slash cutter rotary blade, a skip-cut rotary blade, scallop rotary blade, and/or a wave rotary blade, among others. In addition, the rotary blade 304 may be formed of a variety of material, such as, e.g., steel, stainless steel, and/or titanium bonded steel, among others. Likewise, the rotary cutter 300 and the rotary blade 304 can be configured in a variety of sizes and/or shapes. Further, the rotary cutter 300 is configured to receive rotary blades 304 having notches 330 about their central opening 332 along with rotary blades 304 having a more generally circular central opening 332.

The use of the terms “a” and “an” and “the” and similar referents used in the present application (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate what is being disclosed by the present application and does not pose a limitation on the scope of the disclosure in the present application unless otherwise claimed. No language in the specification should be construed as indicating any non-claimed element as essential to the practice of what is disclosed by the present application.

Those skilled in the art will recognize that a wide variety of modifications, alterations, and combinations can be made with respect to the above-described embodiments without departing from the scope of these teachings, and that such modifications, alterations, and combinations are to be viewed as being within the ambit of the inventive concept.

What is claimed is:

1. A rotary cutter, comprising:
a body having a rear end and a forward end, the forward end including a blade holder configured to receive a rotary blade having an edge;
a first shield slidably connected to the body and configured to move between a first retracted position and a first extended position;
a second shield slidably connected to the body and configured to move between a second retracted position and a second extended position;
wherein when the first shield is in the first extended position it extends beyond a first portion of the edge of the rotary blade and wherein when the second shield is in the second extended position the second shield extends beyond a second portion of the edge of the rotary blade different than the first portion of the rotary blade.

2. The rotary cutter of claim 1, wherein when the first shield is moved from the first extended position to the first retracted position it exposes the first portion of the edge of the rotary blade.

3. The rotary cutter of claim 1, wherein when the second shield is moved from the second extended position to the second retracted position it exposes the second portion of the edge of the rotary blade.

4. The rotary cutter of claim 1, wherein the blade holder having an axle shaft connecting a first expanded end member and a second expanded end member with the axle shaft extending therebetween; and
a retaining clip slidably connected to the body of the rotary cutter and configured to engage with and bias a portion of the blade holder against the body of the rotary cutter when in an extended position and to disengage with and unbias the blade holder from against the body of the rotary cutter while in a retracted position.

5. The rotary cutter of claim 4, wherein the first expanded end member of the axle shaft has a diameter that is less than an opening in the rotary blade and an opening in the body of the rotary cutter and the second expanded end member has a diameter that is greater than the opening in the rotary blade and the opening in the body of the rotary cutter, such that the first expanded end member of the axle shaft can pass through the opening in the rotary blade and the opening in the body of the rotary cutter and the second expanded end member of the axle shaft cannot pass through the opening in the rotary blade or the opening in the body of the rotary cutter.

6. The rotary cutter of claim 5, wherein the retaining clip is configured bias the blade holder against the body of the rotary cutter by engaging with a groove in the axle shaft after the axle shaft has been at least partially extended through the opening in the body of the rotary cutter.

7. The rotary cutter of claim 4, wherein the retaining clip has a first prong having a first angled surface and second prong having a second angled surface that are configured to engage with the groove in the axle shaft and bias the blade holder against the body of the rotary cutter when the retaining clip is in an extended position, wherein the groove is disposed in a straight line about a circumference of the axle shaft.

8. The rotary cutter of claim 1, wherein the body includes a first plurality of grip fins.

9. The rotary cutter of claim 8, wherein the body includes a second plurality of grip fins positioned opposite the first plurality of grip fins.

10. The rotary cutter of claim 1, wherein the rear end of the body has an aperture that extends through the body of the rotary cutter.

11. The rotary cutter of claim 1, wherein the first shield includes a first semicircular portion configured to shield and seat a first portion of the rotary blade while in the first extended position and a shaft that connects the first shield to the body and wherein the second shield includes a second semicircular portion configured to shield and seat a second portion of the rotary blade while in the second extended position; and
wherein the rotary cutter is configured in a use configuration when one or both of the first shield is disposed in the first retracted position or the second shield is disposed in the second retracted position.

12. A rotary cutter, comprising:
a body having a rear end and a forward end, the forward end including a blade holder and configured to receive a rotary blade having an edge;
a shield slidably connected to the body and configured to move between a retracted position and an extended position; and
wherein when the shield is in the extended position it extends beyond the edge of the rotary blade.

13. The rotary cutter of claim 12, wherein when the shield is moved from the extended position to the retracted position it exposes the edge of the rotary blade.

14. The rotary cutter of claim 12, wherein the blade holder includes an axle shaft connecting a first expanded end member and a second expanded end member with the axle shaft extending therebetween; and
a retaining clip slidably connected to the body of the rotary cutter and configured to engage with and bias a portion of the blade holder against the body of the rotary cutter when in an extended position and to disengage with and unbias the portion of the blade holder from against the body of the rotary cutter while in a retracted position.

15. The rotary cutter of claim 14, wherein the first side of the blade holder has a diameter that is greater than an opening in the rotary blade and a opening in the body of the rotary cutter and the second side of the rotary blade has a diameter that is less than the opening in the rotary blade and the opening in the body of the rotary cutter, such that the second side of the blade holder can pass through the opening in the rotary blade and the opening in the body of the rotary cutter and the first side of the blade axle cannot pass through the opening in the rotary blade or the opening in the body of the rotary cutter.

16. The rotary cutter of claim 15, wherein the retaining clip is configured to bias the blade holder against the body of the rotary cutter while in the extended position by engaging with a groove in the axle shaft after the axle shaft of the blade holder has been at least partially extended through the opening in the body of the rotary cutter.

17. The rotary cutter of claim 16, wherein the retaining clip has a first prong having a first angled surface and second prong having a second angled surface that are configured to engage with the groove in the axle shaft of the blade holder to bias the blade holder against the body of the rotary cutter.

18. The rotary cutter of claim 12, wherein the body includes a first grip fin.

19. The rotary cutter of claim 18, wherein the body includes a second grip fin positioned opposite the first grip fin.

20. The rotary cutter of claim 12, wherein the rear end of the body has an aperture that extends through the body of the rotary cutter.

21. A rotary cutter, comprising:
a body having a rear end and a forward end, the forward end including a blade holder configured to receive a rotary blade having an edge;
a first shield slidably connected to a first actuator grip that is configured to move the first shield between a first retracted position and a first extended position;
a second shield slidably connected to a second actuator grip that is configured to move the second shield between a second retracted position and a second extended position;
wherein when the first shield is in the first extended position it extends beyond a first portion of the edge of the rotary blade and wherein when the second shield is in the second extended position the second shield extends beyond a second portion of the edge of the rotary blade different than the first portion of the rotary blade.

22. The rotary cutter of claim 21, wherein when the first shield is in the first extended position it extends beyond the first portion of the edge of the rotary blade by 0.1 mm to 2 mm.

23. The rotary cutter of claim 22, wherein when the second shield is in the second extended position it extends beyond the second portion of the edge of the rotary blade by 0.1 mm to 2 mm.

24. The rotary cutter of claim 21, wherein the body is composed of a plastic material.

25. The rotary cutter of claim 24, wherein the plastic material is one of an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), or a Polystyrene (PS or Styrofoam).

26. The rotary cutter of claim 21, wherein the body has a first grip located on a top side of the body and a second grip located on a bottom side of the body opposite the top side of the body.

27. The rotary cutter of claim 26, wherein the first grip is composed of a rubber material.

28. The rotary cutter of claim 27, wherein the rubber material is one of a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

29. The rotary cutter of claim 26, wherein the first grip is composed of a plastic material.

30. The rotary cutter of claim 29, wherein the plastic material is one of a Thermoplastic Elastomer (TPE) or a Thermoplastic Rubber (TPR).

31. The rotary cutter of claim 21, wherein the first shield has a beaded edge that extends beyond the first portion of the edge of the rotary blade when the first shield is in the first extended position.

32. The rotary cutter of claim 31, wherein the second shield has a second beaded edge that extends beyond the second portion of the edge of the rotary blade when the second shield is in the second extended position.

33. The rotary cutter of claim 21, wherein the first actuator grip and the second actuator grip have a surface composed of a repeating pattern of valleys, wherein the valleys each have a first angular side and a second angular side that meet to form a lowermost point of each of the valleys.

34. The rotary cutter of claim 21, wherein the blade holder has a first side having a first diameter and a second side having a second diameter that is less than the first diameter and an axle shaft extending therebetween.

35. The rotary cutter of claim 21, further comprising a retaining clip having a thumb grip having a textured surface including a repeating pattern of ridges, wherein the ridges each have a first angular side and a second angular side that meet to form a pinnacle of each of the ridges.

36. The rotary cutter of claim 21, wherein the rotary blade is composed of one of a steel, a stainless steel, or a titanium bonded steel.

37. The rotary cutter of claim 21, wherein the rotary blade is one of a pinking rotary blade, a chenille rotary blade, a slash cutter rotary blade, a skip-cut rotary blade, scallop rotary blade, or a wave rotary blade.

38. A rotary cutter, comprising:
a body having a rear end and a forward end, the forward end including a blade holder having a first side and a second side with an axle shaft extending therebetween and configured to receive a rotary blade having an edge;
a retaining clip slidably connected to the body of the rotary cutter and configured to engage with the blade holder when in an extended position and to disengage with the blade holder when in a retracted position;
a shield slidably connected to an actuator grip configured to move the shield between a first position where the shield extends beyond the edge of the rotary blade and a second position where the shield does not extend beyond the edge of the rotary blade.

39. The rotary cutter of claim 38, wherein when the shield is in the first position it extends beyond the edge of the rotary blade by 0.1 mm to 2 mm.

40. The rotary cutter of claim 38, wherein the body is composed of a plastic material.

41. The rotary cutter of claim 40, wherein the plastic material is one of an Acrylonitrile Butadiene Styrene (ABS), Polyethylene Terephthalate (PET or PETE), a High-Density Polyethylene (HDPE), a Polyvinyl Chloride (PVC or Vinyl), a Low-Density Polyethylene (LDPE), a Polypropylene (PP), or a Polystyrene (PS or Styrofoam).

42. The rotary cutter of claim 38, wherein the body has a first grip located on a top side of the body and a second grip located on a bottom side of the body opposite the top side of the body.

43. The rotary cutter of claim 42, wherein the first grip is composed of a rubber material.

44. The rotary cutter of claim 43, wherein the rubber material is one of a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

45. The rotary cutter of claim 42, wherein the first grip and the second grip are made from a plastic material.

46. The rotary cutter of claim 45, wherein the plastic material is one of a Thermoplastic Elastomer (TPE) or a Thermoplastic Rubber (TPR).

47. The rotary cutter of claim 38, wherein the shield has a beaded edge that extends beyond the edge of the rotary blade when the shield is in the second position.

48. The rotary cutter of claim 38, wherein the actuator grip has a surface composed of a repeating pattern of valleys, wherein each of the valleys have a first angular side and a second angular side that meet to form a lowermost portion of each of the valleys.

49. The rotary cutter of claim 38, wherein the retaining clip has a thumb grip having a textured surface composed of a repeating pattern of ridges, wherein each of the ridges have a first angular side and a second angular side that meet to form a pinnacle of each of the ridges.

50. The rotary cutter of claim 38, wherein the rotary blade is composed of one of a steel, a stainless steel, or a titanium bonded steel.

51. The rotary cutter of claim 38, wherein the rotary blade is one of a pinking rotary blade, a chenille rotary blade, a slash cutter rotary blade, a skip-cut rotary blade, scallop rotary blade, or a wave rotary blade.

52. The rotary cutter of claim 38, wherein the first shield having a first semicircular portion configured to shield and seat a first portion of the rotary blade while in the first extended position and an attachment portion that connects the first shield to the body;
the second shield having a second semicircular portion configured to shield and seat a second portion of the rotary blade while in the second extended position; and
wherein the rotary cutter is configured to be in a use configuration when either or both of the first shield and the second shield is in an at least partially retracted position.
